(19) United States
(12) Patent Application Publication
(10) Pub. No.: US 2020/0301298 A1
(43) Pub. Date: Sep. 24, 2020

(54) TONER FOR DEVELOPING ELECTROSTATIC IMAGE, TONER ACCOMMODATING UNIT, AND IMAGE FORMING APPARATUS

(71) Applicants: Ryota INOUE, Shizuoka (JP); Hiroshi Yamashita, Shizuoka (JP); Minoru Masuda, Shizuoka (JP); Yuka Mizoguchi, Shizuoka (JP); Daichi Hisakuni, Shizuoka (JP)

(72) Inventors: Ryota INOUE, Shizuoka (JP); Hiroshi Yamashita, Shizuoka (JP); Minoru Masuda, Shizuoka (JP); Yuka Mizoguchi, Shizuoka (JP); Daichi Hisakuni, Shizuoka (JP)

(21) Appl. No.: 16/822,078

(22) Filed: Mar. 18, 2020

(30) Foreign Application Priority Data
Mar. 19, 2019 (JP) 2019-051445

(51) Int. Cl. G03G 9/09; G03G 9/08; G03G 9/087

(52) U.S. Cl. CPC G03G 9/0902; G03G 9/08755; G03G 9/0827; G03G 9/0926

(57) ABSTRACT

A toner for developing an electrostatic image is provided. The toner comprises a binder resin and a glitter pigment having an average surface roughness Ra of 100 nm or less.

### CROSS-REFERENCE TO RELATED APPLICATIONS

This patent application is based on and claims priority pursuant to 35 U.S.C. § 119(a) to Japanese Patent Application No. 2019-051445, filed on Mar. 19, 2019, in the Japan Patent Office, the entire disclosure of which is hereby incorporated by reference herein.

### BACKGROUND

### Technical Field

The present disclosure relates to a toner for developing an electrostatic image, a toner accommodating unit, and an image forming apparatus.

### Description of the Related Art

As electrophotographic color image forming apparatuses have been widely spread, their applications have been diversified. There is a demand for metallic-tone image in addition to conventional color image.

What is called a glitter toner that contains a glitter pigment in a binder resin has been used to form an image having glitter texture like metal.

Such an image with metallic luster should exhibit strong light reflectivity when viewed from a certain angle. To achieve this, a highly-reflective pigment (“glitter pigment”) having a scale-like plane is generally blended in toner.

Suitable examples of the highly-reflective pigment include metals and metal-coated pigments. For securing reliable reflectivity, pigment particles each having a plane with a certain degree of area should be arranged in a planar form in a fixed toner image.

### SUMMARY

In accordance with some embodiments of the present invention, a toner for developing an electrostatic image is provided. The toner comprises a binder resin and a glitter pigment having an average surface roughness Ra of 100 nm or less.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawing, which is intended to depict example embodiments of the present invention and should not be interpreted to limit the scope thereof. The accompanying drawing is not to be considered as drawn to scale unless explicitly noted.

The accompanied drawing is a schematic diagram illustrating an image forming apparatus according to an embodiment of the present invention.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

In attempting to obtain a metallic coating film having excellent metallic appearance and design, an aluminum pigment comprised of flake-like aluminum powder having a resin coating has been proposed.

Further, a toner having an average molecular weight of from 15,000 to 300,000 for providing a certain degree of image reflectance has been proposed in attempting to provide excellent glittering property.

Further, a highly-glittering toner having a low molecular weight has been proposed in attempting to prevent the occurrence of toner scattering in a high-temperature high-humidity environment.

In accordance with some embodiments of the present invention, a toner for forming a glittering image is provided that prevents peeling of the image while ensuring the glitter of the image.

Conventionally, it has been considered that a glittering toner image is achieved when the planes of the glitter pigment particles are aligned at the surface of the image and light is effectively reflected by the planes.

However, since the glitter pigments have a flat-plate-like shape, when the planes are arranged side by side at narrow intervals in the image particularly formed of the conventional toner which has a high molecular weight, the adhesive force between the flat-plate-like glitter pigments and the binder resin is weakened, which causes a problem that the image is peeled off at the interface with the glitter pigments when the image is rubbed.

The conventional glitter pigment which is covered with a resin may lose surface smoothness and glittering property, although the adhesion between the glitter pigment and the resin is increased.

Further, the conventional toner which has a low molecular weight may have a low margin in the fixing temperature, although the adhesion between the glitter pigment and the resin is increased.

Therefore, the above-described conventional toners are insufficient for providing a toner for forming a glittering image that provides a wide fixable temperature range and prevents peeling of the image.

As a result of intensive studies, the inventors of the present invention have found that the above-described problems are solved when the surface roughness of the glitter pigment is small. When the average surface roughness Ra is 100 nm or less, the regular reflectance of light at the surface is large, so that extremely excellent light brightness and good flop property are exhibited. Further, the adhesion to the resin is enhanced, and image peeling is prevented.

A toner according to an embodiment of the present invention and a method for manufacturing the toner are described in detail below.

### Toner

The toner according to an embodiment of the present invention contains a glitter pigment having a surface roughness Ra of 100 nm or less and a binder resin, and may further contain other components such as a colorant and a release agent, as necessary.

As described above, when the average surface roughness Ra of the glitter pigment is 100 nm or less, the regular reflectance of light at the surface is large, so that extremely excellent light brightness and good flop property are exhibited.

As a result of intensive studies, the inventors of the present invention have found that, in a fixed image of a toner containing glitter pigments, it is likely that the pigments come close to or into contact with each other since the pigments are in a scale-like (flat-plate-like) or flat shape. This causes a problem that the image is easily peeled off at the interface between the pigments.

To avoid such a problem, it is preferable that the toner according to an embodiment of the present invention contain a polyester resin (A) that is insoluble in THF as a binder resin.

In addition, the molecular weight of the toner is preferably low. Specifically, it has been found that a resin having a weight average molecular weight (Mw) of from 5,000 to 14,000 in terms of polystyrene measured by GPC has good adhesion to the pigment and prevents the pigments from being contact with each other.

When the weight average molecular weight of the toner is less than 5,000, hot offset occurs when the toner is fixed at a high temperature. When the weight average molecular weight of the toner is larger than 14,000, the adhesion between the pigment and the resin is poor.

When the polyester resin (A) is a high-molecular-weight body or three-dimensionally-cross-linked body that is insoluble in THF and the gel components thereof has a glass transition temperature (Tg) of from −60 to 10 degrees C., the toner behaves as rubber and is likely to deform at low temperatures. On the other hand, the toner is prevented from excessively flowing, so that the occurrence of hot offset is prevented and the fixable temperature range is widen. When the glass transition temperature (Tg) is within a certain range, the resin exhibits high fluidity at low temperatures, which makes it possible that the resin enters the gaps between the pigments to prevent the pigments from coming close to or into contact with each other. When the Tg is −60 degrees C. or higher, the glass transition temperature of the toner is not too low, which is preferable for heat-resistant storage stability. When the Tg is 10 degrees C. or lower, the fluidity is sufficient at low temperatures, which makes it easy for the resin to enter the gap between the pigments. A more preferred temperature range is from −40 to 0 degrees C.

The proportion of the polyester resin insoluble in THF contained in the toner is preferably from 5% to 15% by mass. When the proportion of insoluble matter is 5% by mass or more, the adhesion between the pigment and the resin is sufficient, and the pigments are prevented from coming into contact with each other. When the proportion thereof is 15% by mass or less, the lower-limit fixable temperature is lowered without lowering the margin in fixing.

A toner containing a pigment having a certain thickness and a resin having a very low Tg and a cross-linked structure, even when the molecular weight of the toner is low, is prevented from causing high-temperature offset and exhibits a wide margin in fixing. Such a resin having a low Tg and high flowability enhances the adhesion between the glitter pigment and the binder resin, thereby preventing the pigments from coming close to or into contact with each other to prevent peeling of the image.

### Weight Average Molecular Weight (Mw) of THF-Soluble Matter

In the present disclosure, the molecular weight distribution and weight average molecular weight (Mw) of tetrahydrofuran-soluble matter of the toner or binder resin were measured using a gel permeation chromatographic (GPC) measuring instrument (such as HLC-8220 GPC available from Tosoh Corporation). As columns, TSKgel SuperHZM-H 15 cm in 3-tandem (available from Tosoh Corporation) were used. First, the resin to be measured was dissolved in tetrahydrofuran (THF, containing a stabilizer, available from FUJIFILM Wako Pure Chemical Corporation) to prepare a 0.15% by mass solution thereof. The solution was filtered with a 0.2-μm filter, and the resulting filtrate was used as a specimen. Next, 100 μl of the specimen (i.e., THF solution of the resin) was injected into the measuring instrument and subjected to a measurement at 40 degrees C. and a flow rate of 0.35 ml/min.

A molecular weight was calculated using a calibration curve created from monodisperse polystyrene standard samples.

As the monodisperse polystyrene standard samples, Showdex STANDARD series available from Showa Denko K.K. and toluene were used.

The following three types of THF solutions A, B, and C of monodisperse polystyrene standard samples were prepared and subjected to a measurement under the above-described conditions. A calibration curve was created with light-scattering molecular weights, represented by retention time of the peaks, of the monodisperse polystyrene standard samples.
Solution A: 2.5 mg of S-7450, 2.5 mg of S-678, 2.5 mg of S-46.5, 2.5 mg of 5-2.90, and 50 mL of THF
Solution B: 2.5 mg of S-3730, 2.5 mg of S-257, 2.5 mg of S-19.8, 2.5 mg of S-0.580, and 50 mL of THF
Solution C: 2.5 mg of S-1470, 2.5 mg of S-112, 2.5 mg of S-6.93, 2.5 mg of toluene, and 50 mL of THF
As the detector, an RI (refractive index) detector was used.

### Polyester Resin (A) Insoluble in THF

THF-insoluble matter of the toner may be isolated by a dissolution filtration method or a method using Soxhlet extraction to obtain extraction residue, each of which can be used without any problem. In the present disclosure, THF-insoluble matter was isolated by a dissolution filtration method in the following manner. In the present disclosure, the pigment is excluded from the THF-insoluble matter.

A procedure for isolating THF-insoluble matter of the toner by the dissolution filtration method is as follows.

First, 1 g of the toner was weighed, put in 100 mL of THF, and stirred using a stirrer for 6 hours at 25 degrees C. Thus, a solution of soluble matter of the toner was obtained. Next, the solution was filtered with a membrane filter having an opening of 0.2 μm. The filtrate was put in 50 mL of THF again and stirred using a stirrer for 10 minutes. The above-described operation was repeated two to three times. The filtrate was dried in an environment at 120 degrees C. and 10 kPa or less, thus obtaining THF-insoluble matter.

In the method using Soxhlet extraction, it is preferable that 1 part of the toner and 100 parts of THF be subjected to a reflux for 6 hours or more to separate THF-insoluble matter and THF-soluble matter from each other.

In the present disclosure, the glass transition temperature of the toner, THF-insoluble matter of the toner, and resin can be measured using a differential scanning calorimeter (DSC) (e.g., Q-200 available from TA Instruments) as follows. First, about 5.0 mg of a sample is put in an aluminum sample container. The sample container is put on a holder unit and set in an electric furnace. In a measurement, the temperature is raised from −80 degrees C. to 150 degrees C. at a temperature rising rate of 10 degrees C./min (“first temperature rise process”) in a nitrogen atmosphere. Subsequently, the temperature is lowered from 150 degrees C. to −80 degrees C. at a temperature falling rate of 10 degrees C./min (“temperature fall process”) and raised to 150 degrees C. again at a temperature rising rate of 10 degrees C./min (“second temperature rise process”). During these processes, a change in the amount of heat absorption/generation is measured. A DSC curve is obtained by drawing a graph showing a relation between the temperature and the amount of heat absorption/generation.

The obtained DSC curves are analyzed with an analysis program installed in the system of Q-200. The glass transition temperature of the sample is determined by selecting the DSC curve obtained in the first temperature rise process and determining the intersection of an extended line of the base line of the DSC curve at a temperature lower than the temperature at which enthalpy relaxation of the amount of heat absorption occurs, and a tangent line of the DSC curve indicating the maximum inclination at the enthalpy relaxation. In the case of a sample having a melting point, the peak top temperature at which the amount of heat absorption becomes maximum in the DSC curve obtained in the first temperature rise process is determined as the melting point.

### Polyester Resin (A)

The polyester resin (A) is described in detail below.

The polyester resin (A) is a resin that is insoluble in THF, and any resin can be used therefor as long as the above-described conditions are satisfied. Preferred examples thereof include a resin that behaves as rubber in an environment at a temperature at which the toner is to be used. Accordingly, preferably, the polyester resin (A) has a cross-linked structure, has a glass transition temperature in a low temperature region of 20 degrees C. or lower, and exhibits a viscoelastic behavior having a rubber-like flat region in an environment at room temperature or higher.

It is preferable that urethane bond or urea bond have been introduced into the polyester resin (A), because the resultant resin is provided with excellent rubber elasticity due to its intermolecular cohesive force, which provides a toner having excellent heat-resistant storage stability and mechanical durability. It is possible that the storage elastic modulus of THF-insoluble matter of the toner is adjusted by controlling the concentration of urethane bond or urea bond in the resin structure.

The polyester resin (A) having a cross-linked structure may be obtained through any procedure without any problem. For example, the polyester resin (A) may be obtained by reacting a reactive precursor (hereinafter also referred to as “prepolymer”) with a curing agent. The polyester resin (A) may be introduced into the toner by preparing the polyester resin (A) having a cross-linked structure through a reaction and then introducing it into the toner; or granulating toner particles while reacting the reactive precursor with the curing agent therein, so that the polyester resin (A) having a cross-linked structure gets introduced into the toner particles. The latter is more preferred because the polyester resin (A) can be uniformly introduced into the toner and the toner quality is uniform.

The reactive precursor is not particularly limited and can be suitably selected to suit to a particular application as long as it is a polyester resin having a group reactive with the curing agent.

Examples of the group reactive with the curing agent in the reactive precursor include, but are not limited to, a group reactive with an active hydrogen group. Examples of the group reactive with an active hydrogen group include, but are not limited to, isocyanate group, epoxy group, carboxylic acid group, and an acid chloride group. Among these groups, isocyanate group is preferred because urethane bond or urea bond can be introduced into the resulting polyester resin (A).

The reactive precursor may have a branched structure provided by at least one of a trivalent or higher alcohol and a trivalent or higher carboxylic acid.

Examples of the polyester resin having isocyanate group include, but are not limited to, a reaction product of a polyester resin having an active hydrogen group with a polyisocyanate. The polyester resin having an active hydrogen group may be obtained by, for example, a polycondensation of a diol, a dicarboxylic acid, and at least one of a trivalent or higher alcohol and a trivalent or higher carboxylic acid. The trivalent or higher alcohol and the trivalent or higher carboxylic acid impart a branched structure to the resulting polyester resin having isocyanate group.

Examples of the diol include, but are not limited to: aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol; diols having an oxyalkylene group, such as diethylene glycol, triethylene glycol, dipropylene glycol, polyethylene glycol, polypropylene glycol, and polytetramethylene glycol; alicyclic diols such as 1,4-cyclohexanedimethanol and hydrogenated bisphenol A; alicyclic diols to which to which an alkylene oxide (e.g., ethylene oxide, propylene oxide, butylene oxide) is adducted; bisphenols such as bisphenol A, bisphenol F, and bisphenol S; and alkylene oxide adducts of bisphenols, such as bisphenols to which an alkylene oxide (e.g., ethylene oxide, propylene oxide, butylene oxide) is adducted.

Among these, for adjusting the glass transition temperature of the polyester resin (A) to 20 degrees C. or lower, aliphatic diols having 3 to 10 carbon atoms are preferred, such as 1,2-propylene glycol, 1,3-propylene glycol, 1,4-butanediol, 2-methyl-1,3-propanediol, 1,5-pentanediol, and 3-methyl-1,5-pentanediol. More preferably, the diol accounts for 50% by mol or more of alcohol components in the resin. Each of these diols can be used alone or in combination with others.

Desirably, the polyester resin (A) is an amorphous resin. Further, the resin chain may be given a steric hindrance so that melt viscosity is reduced at the time when the toner gets fixed and the toner more easily develop low-temperature fixability. Thus, it is preferable that the main chain of the aliphatic diol have a structure represented by the following general formula (1).

HOCR₁R₂ₙOH General Formula (1)

where R₁ and R₂ each independently represent hydrogen atom or an alkyl group having 1 to 3 carbon atoms, n represents an odd number of from 3 to 9, and each of R₁ and R₂ in each repeating unit is either the same as or different from R₁ and R₂, respectively, in another repeating unit.

Here, the main chain of the aliphatic diol refers to a carbon chain that connects two hydroxyl groups of the aliphatic diol with the smallest number of carbon atoms. When the number of carbon atoms in the main chain is an odd number, the crystallinity is reduced due to parity, which is preferable. When at least one or more alkyl groups having 1 to 3 carbon atoms are included in a side chain, the interaction energy between molecules in the main chain is reduced due to stericity, which is preferable.

Examples of the dicarboxylic acid include, but are not limited to: aliphatic dicarboxylic acids such as succinic acid, adipic acid, sebacic acid, dodecanedioic acid, maleic acid, and fumaric acid; and aromatic dicarboxylic acids such as phthalic acid, isophthalic acid, terephthalic acid, and naphthalenedicarboxylic acid. In addition, anhydrides, lower (C1-C3) alkyl esters, and halides thereof may also be used. Among these, for adjusting the Tg of the polyester resin (A) to 20 degrees C. or lower, aliphatic dicarboxylic acids having 4 to 12 carbon atoms are preferred. More preferably, the dicarboxylic acid accounts for 50% by mass or more of carboxylic acid components in the resin. Each of these dicarboxylic acids can be used alone or in combination with others.

Examples of the trivalent or higher alcohol include, but are not limited to: trivalent or higher aliphatic alcohols such as glycerin, trimethylolethane, trimethylolpropane, pentaerythritol, and sorbitol; trivalent or higher polyphenols such as trisphenol PA, phenol novolac, and cresol novolac; and alkylene oxide adducts of trivalent or higher polyphenols, such as trivalent or higher polyphenols to which an alkylene oxide (e.g., ethylene oxide, propylene oxide, butylene oxide) is adducted.

Examples of the trivalent or higher carboxylic acid include, but are not limited to, trivalent or higher aromatic carboxylic acids. In particular, trivalent or higher aromatic carboxylic acids having 9 to 20 carbon atoms, such as trimellitic acid and pyromellitic acid, are preferred. In addition, anhydrides, lower (C1-C3) alkyl esters, and halides thereof may also be used.

Examples of the polyisocyanate include, but are not limited to, diisocyanates and trivalent or higher isocyanates.

The polyisocyanate is not particularly limited and can be suitably selected to suit to a particular application. Examples thereof include, but are not limited to: aromatic diisocyanates such as 1,3-phenylene diisocyanate, 1,4-phenylene diisocyanate, 2,4-tolylene diisocyanate (TDI), 2,6-tolylene diisocyanate (TDI), crude TDI, 2,4′-diphenylmethane diisocyanate (MDI), 4,4′-diphenylmethane diisocyanate (MDI), crude MDI [also known as polyallyl polyisocyanate (PAPI), that is a phosgenation product of crude diaminophenylmethane (that is a condensation product of formaldehyde with an aromatic amine (e.g., aniline) or mixture thereof, where the “an aromatic amine (e.g., aniline) or mixture thereof” includes a mixture of diaminodiphenylmethane with a small amount (e.g., 5 to 20% by mass) of a polyamine having 3 or more functional groups)], 1,5-naphthylene diisocyanate, 4,4′,4″-triphenylmethane triisocyanate, m-isocyanatophenylsulfonyl isocyanate, and p-isocyanatophenylsulfonyl isocyanate; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; alicyclic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5-norbornane diisocyanate, and 2,6-norbornane diisocyanate; araliphatic diisocyanates such as m-xylylene diisocyanate (XDI), p-xylylene diisocyanate (XDI), and α,α,α′,α′-tetramethylxylylene diisocyanate (TMXDI); trivalent or higher polyisocyanates such as lysine triisocyanate and diisocyanate-modified trivalent or higher alcohols; and modified products of these isocyanates. Each of these compounds may be used in combination with others. Examples of the modified products of the isocyanates include, but are not limited to, those having urethane group, carbodiimide group, allophanate group, urea group, biuret group, uretdione group, uretonimine group, isocyanurate group, or oxazolidone group.

The curing agent is not particularly limited and can be suitably selected to suit to a particular application. Examples thereof include, but are not limited to, an active-hydrogen-group-containing compound.

Examples of the active hydrogen group in the active-hydrogen-group-containing compound include, but are not limited to, hydroxyl groups (e.g., alcoholic hydroxyl group, phenolic hydroxyl group), amino group, carboxyl group, and mercapto group. Each of these can be used alone or in combination with others.

Preferably, the active-hydrogen-group-containing compound is an amine, because amines are capable of forming urea bond.

Examples of the amine include, but are not limited to: aromatic diamines such as phenylenediamine, diethyltoluenediamine, and 4,4′-diaminodiphenylmethane; alicyclic diamines such as 4,4′-diamino-3,3′-dimethyldicyclohexylmethane, diaminocyclohexane, and isophoronediamine; aliphatic diamines such as ethylenediamine, tetramethylenediamine, and hexamethylenediamine; trivalent or higher amines such as diethylenetriamine and triethylenetetramine; aminoalcohols such as ethanolamine and hydroxyethylaniline; aminomercaptans such as aminoethylmercaptan and aminopropylmercaptan; amino acids such as aminopropionic acid and aminocaproic acid; and ketimine compounds obtained by blocking these amino groups with ketones such as acetone, methyl ethyl ketone, and methyl isobutyl ketone, and oxazoline compounds. Each of these can be used alone or in combination with others. In particular, a diamine alone and a mixture of a diamine with a small amount of a trivalent or higher amine are preferred.

### Glitter Pigment

Preferably, the glitter pigment is a metallic pigment, to efficiently reflect light. Examples of the metallic pigment include, but are not limited to: powders of metals such as aluminum, brass, bronze, nickel, stainless steel, zinc, copper, silver, gold, and platinum; and metal-vapor-deposited flake-like glass powder. Among these, aluminum is preferred, because the light reflectance is high and a decrease in reflectance due to oxidation is low. Preferably, the glitter pigment is surface-treated for improving dispersibility and contamination resistance. The glitter pigment may be coated with a surface treatment agent, a silane coupling agent, a titanate coupling agent, a fatty acid, a silica particle, an acrylic resin, and/or a polyester resin.

Preferably, the glitter pigment is in a scale-like (flat-plate-like) or flat shape to have a light reflective plane. Glittering property is exhibited by such a configuration. One type of glitter pigment may be used alone, or two or more types of glitter pigments may be used in combination. For adjusting color tone, other colorants such as dyes and pigments may be used in combination.

Preferably, the proportion of the glitter pigment in the toner is from 5% to 50% by mass.

Preferably, the glitter pigment is comprised of aluminum flakes obtained by pulverizing an aluminum foil, and more preferably, vapor-deposited aluminum flakes obtained by pulverizing an aluminum-deposited substrate having improved surface smoothness, for achieving high metallic texture by enhancing brightness.

Preferably, such a glitter pigment has a volume average particle diameter of from 8 to 20 μm. When the average particle diameter is 8 μm or more, the orientation does not deteriorate. When the average particle diameter is 20 μm or less, there is no possibility that the corrosion resistance is lowered due to a part of the glitter pigment protruding from the glitter pigment-containing layer.

Preferably, the glitter pigment has a thickness of from 25 to 200 nm. When the glitter pigment is excessively thin, the amount of light transmitted through the glitter pigment is increased, which is disadvantageous in increasing the brightness in highlight portions. In addition, when the thickness of the glitter pigment is too small with respect to the particle diameter thereof, the glitter pigment is easily deformable, which is disadvantageous in terms of orientation. Therefore, the thickness of the glitter pigment is preferably 0.4% or more of the particle diameter thereof, for example, 30 nm or more.

On the other hand, when the glitter pigment is excessively thick, the orientation thereof deteriorates. In addition, the volume ratio of the glitter pigment required to secure glittering property increases in the glitter pigment-containing layer, degrading coating film properties. Therefore, preferably, the thickness of the glitter pigment is 200 nm or less. More preferably, the thickness of the glitter pigment is from 80 to 150 nm.

One example method for producing the glitter pigment is described below.

First, an ethyl acetate solution of methacrylate polymer is applied to the surface of a support made of a polyester film, and the ethyl acetate is evaporated to form a release layer made of a methacrylate polymer film. Next, aluminum is vacuum-deposited on the surface of the release layer to form an aluminum layer. The polyester film having the aluminum layer thereon is put in ethyl acetate to dissolve the release layer, thereby obtaining crushed aluminum flakes. These aluminum flakes are pulverized with a homogenizer or the like, and the pulverized product is filtered and washed to obtain a glitter pigment.

A glitter pigment having a resin coating layer is formed as follows. First, a release layer is formed on the surface of a polyester film in the same manner as described above, then a resin layer is formed on the surface of the release layer, and an aluminum layer is formed on the surface of the resin layer by vacuum deposition. Next, a resin layer is formed on the surface of the aluminum layer. The polyester film having the resin layer and the aluminum layer thereon is put in ethyl acetate to dissolve the release layer, thereby obtaining aluminum flakes having a resin coating layer. These aluminum flakes having a resin coating layer are pulverized with a homogenizer or the like, and the pulverized product is filtered and washed to obtain a glitter pigment having a resin coating layer.

The average surface roughness of the glitter pigment is adjusted by adjusting the surface roughness of the release layer. The thickness of the pigment is adjusted by adjusting the amount of vapor deposition of aluminum. The average particle diameter of the pigment is adjusted by adjusting the pulverizing time and the pulverizing medium.

### Average Surface Roughness (Ra)

The average surface roughness Ra is calculated in the following manner.

For observing surface morphology of the aluminum pigment, an atomic force microscope (hereinafter abbreviated as “AFM”) TMX-2010 (manufactured by TopoMetrix Corporation) is used. As a pretreatment, the glitter pigment as a specimen is ultrasonically washed with excess methanol and chloroform, dried in vacuum, dispersed again in acetone, dropped on a Si wafer, and naturally dried. The surface roughness is quantified using AFM as follows. A powdery aluminum flake which is not overlapped with other powdery aluminum flakes is subjected to a measurement of a surface roughness profile (line profile of surface unevenness) through 300 times of scans in a 5 μm-square field of view, and the arithmetic average roughness of the roughness profile (the arithmetic average of the absolute values of peaks within the sampling length of 5 μm) is determined.

The sampling length is 5 μm, but it depends on the average particle diameter d50. The arithmetic average roughness is measured in three or more fields of view, and the arithmetic average value of the measured arithmetic average roughness values is defined as “average surface roughness Ra (nm)”. The term “surface roughness” is used based on JIS (Japanese Industrial Standards) B0660:1998. The average surface roughness Ra is 100 nm or less, preferably 60 nm or less. When the average surface roughness Ra is 60 nm or less, the regular reflectance of light at the surface is large, so that extremely excellent light brightness and good flop property are exhibited.

### Average Thickness

The average thickness t (nm) is a value obtained by measuring a water surface diffusion area WCA (m²/g) per 1 g of metallic components and calculating by the following equation.

t(nm)=400/[WCA(m²/g)]

This method of calculating the average thickness is described in, for example, the publication entitled “Aluminum Paint and Powder, J. D. Edwards, 2nd Edition, Reinhold Publishing Corporation”.

The water surface diffusion area is determined in accordance with JIS (Japanese Industrial Standards) K5906-1998 after a pretreatment. The method of measuring the water surface diffusion area described in JIS K5906-1998 is of a leafing type, while that described in WO99/54074 is of a non-leafing type. Except for pretreating a sample with a 5% stearic acid mineral spirit solution, the operation procedure in the non-leafing type is the same as that in the leafing type. The pretreatment is described on pp. 2-16 of the publication entitled Paint Raw Material Time Report, No. 156, issued by Asahi Kasei Corporation on Sep. 1, 1980.

### Circularity of Toner

Preferably, the toner according to an embodiment of the present invention has a circularity of from 0.950 to 0.985.

When the toner has a high level of circularity (in other words, the toner has a spherical shape), the glitter pigments can be distributed within the toner at a certain distance. As a result, the glitter pigments are prevented from coming close to or into contact with each other in the fixed image, preventing peeling off of the fixed image.

When the circularity is 0.950 or more, the glitter pigments are prevented from coming close to or into contact with each other, preventing peeling off of the fixed image. When the circularity is 0.985 or less, the toner is well removable with a blade, and a streaky abnormal image is hardly generated. Generally, an abnormal image has a non-smooth surface, which is likely to cause image peeling.

Here, the “circularity” refers to an average circularity measured using a flow particle image analyzer FPIA-3000 (manufactured by Toa Medical Electronics Co., Ltd.) in the following manner. First, 0.1 to 0.5 mL of a surfactant, preferably an alkylbenzene sulfonate, serving as a dispersant, is added to 100 to 150 mL of water from which solid impurities have been removed, and further 0.1 to 0.5 g of a sample (toner) is added thereto. The resulting suspension liquid in which the toner is dispersed is subjected to a dispersion treatment using an ultrasonic disperser for about 1 to 3 minutes. The resulting dispersion liquid containing 3,000 to 10,000 toner particles/μL is set to the above-described analyzer and subjected to a measurement of toner shape and distribution to determine the circularity.

The below-described procedure is effective for obtaining a nearly spherical toner having a desired circularity defined in the present disclosure.

### (1) Procedure 1 for Adjusting Circularity of Toner and Distance Between Glitter Pigments

One preferred method for producing the toner includes the process of dispersing an organic liquid in an aqueous medium to prepare an oil-in-water emulsion, where the organic liquid contains the glitter pigment and optionally a substance capable of being in at least one of a needle-like state or a plate-like state. As oil droplets are formed in the aqueous medium, the glitter pigments are allowed to freely move in the oil droplets and prevented from aligned in one direction. The oil droplets thereafter become toner particles in which the glitter pigments and the needle-like or plate-like substance are fixed. Thus, the toner particles are prevented from being in a flat shape.

The above method for producing the toner is preferably embodied by a dissolution suspension method in which oil droplets are prepared by dissolving or dispersing a toner binder resin, a colorant, etc., in an organic solvent, or a suspension polymerization method in which radical-polymerizable monomers are used.

### (2) Procedure 2 for Adjusting Shape of Toner

A flat shape of toner particles may be corrected by reducing the viscosity of the oil droplets in the aqueous medium while applying a shearing force thereto, in the process of producing the toner. When solvent removal is on the way in the dissolution suspension method or when the polymerization conversion is on the way in the suspension polymerization method, an ellipsoidal shape of toner particles can be corrected into a substantially spherical shape by applying a shearing force to the dispersion liquid.

### (3) Procedure 3 for Adjusting Shape of Toner

In a case in which the glitter pigment is covered with a resin, it is preferable that the surface of the toner be made to have high viscoelasticity.

Specifically, it is preferable that reactive functional groups are preferentially disposed at the surface of the toner to cause a polymeric or cross-linking reaction.

For example, materials capable of reacting at the interface of the oil droplet and the aqueous medium in the process of producing the toner are used. One of the materials is a reactive prepolymer put in the oil droplets. The other is a substance reactive with the prepolymer put in the aqueous medium.

It is also effective to dispose solid particles at the surface of the toner so that the viscoelasticity of the surface of the toner is maintained high. For example, organically-modified inorganic particles that are easy to orient at the oil-water interface may be put in the oil droplets. Specific examples of the organically-modified inorganic particles include, but are not limited to, organically-modified bentonite, organically-modified montmorillonite, and organic-solvent-dispersible colloidal silica.

### Other Materials

The toner may further contain components other than the binder resin, such other resins, a colorant, a wax, a charge controlling agent, an external additive, a fluidity improving agent, a cleanability improving agent, and a magnetic material, as necessary, as long as the effects of the present invention are not impaired.

The other resins are not particularly limited and can be suitably selected from known resins to suit to a particular application. Examples thereof include, but are not limited to: homopolymers of styrene or substituted products thereof, such as polystyrene, poly p-styrene, and polyvinyl toluene; styrene copolymers such as styrene-p-chlorostyrene copolymer, styrene-propylene copolymer, styrene-vinyltoluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isopropyl copolymer, and styrene-maleate copolymer; and polymethyl methacrylate resin, polybutyl methacrylate resin, polyvinyl chloride resin, polyvinyl acetate resin, polyethylene resin, polyester resin, polyurethane resin, epoxy resin, polyvinyl butyral resin, polyacrylic acid resin, rosin resin, modified rosin resin, terpene resin, phenol resin, aliphatic or aromatic hydrocarbon resin, aromatic petroleum resin, and these resins modified to have a functional group reactive with an active hydrogen group. Each of these may be used alone or in combination with others.

Preferred examples of the other resins include resins compatible with the polyester resin (A), for adjusting the glass transition temperature and storage elastic modulus of the toner to within the preferred ranges. More preferably, the other resin is a polyester resin (B). The presence of a compatible resin in the cross-linked structure of the polyester resin (A) having high rubber elasticity makes it possible to provide a toner exhibiting excellent melting property in the fixing temperature range despite of having a high-order cross-linked structure.

To control the glass transition temperature of the toner, preferably, the compatible polyester resin (B) has a glass transition temperature of from 30 to 80 degrees C., more preferably from 40 to 75 degrees C.

The compatible polyester resin is preferably a linear or non-linear polyester resin soluble in THF or an unmodified polyester resin. Here, the unmodified polyester resin refers to a polyester resin that is obtained from a polyol and a polycarboxylic acid or derivative thereof (e.g., a polycarboxylic acid anhydride, a polycarboxylic acid ester) and that is unmodified with an isocyanate compound or the like.

Examples of the polyol include, but are not limited to: alkylene (C2-C3) oxide adducts (with an average addition molar number of 1 to 10) of bisphenol A, such as polyoxypropylene(2.2)-2,2-bis(4-hydroxyphenyl)propane and polyoxyethylene(2.2)-2,2-bis(4-hydroxyphenyl)propane; ethylene glycol and propylene glycol; diols such as hydrogenated bisphenol A and alkylene (C2-C3) oxide adducts (with an average addition molar number of 1 to 10) of hydrogenated bisphenol A; and trivalent or higher alcohols such as glycerin, pentaerythritol, and trimethylolpropane. Each of these can be used alone or in combination with others.

Examples of the polycarboxylic acid include, but are not limited to: adipic acid, phthalic acid, isophthalic acid, terephthalic acid, fumaric acid, and maleic acid; dicarboxylic acids such as succinic acid substituted with an alkyl group having 1 to 20 carbon atoms or an alkenyl group having 2 to 20 carbon atoms, such as dodecenyl succinic acid and octyl succinic acid; and trivalent or higher carboxylic acids such as trimellitic acid, pyromellitic acid, and acid anhydrides thereof. Each of these can be used alone or in combination with others.

The molecular weight of the polyester resin (B) is not particularly limited. However, when the molecular weight is too low, heat-resistant storage stability, chargeability, and mechanical durability (i.e., resistance to stresses, such as that caused by stirring in a developing device) of the toner may be poor. When the molecular weight is too high, the viscoelasticity of the toner at melting is too high, resulting in poor low-temperature fixability. The weight average molecular weight (Mw) measured by GPC (gel permeation chromatography) is preferably from 5,000 to 20,000, more preferably from 7,000 to 12,000. The number average molecular weight (Mn) is preferably from 1,000 to 4,000, more preferably from 1,500 to 3,000. The ratio Mw/Mn is preferably from 1.0 to 4.0, more preferably from 1.0 to 3.5.

The acid value of the polyester resin is not particularly limited, but is preferably from 1 to 50 mgKOH/g, more preferably from 5 to 30 mgKOH/g. When the acid value is 1 mgKOH/g or more, the toner is more negatively-chargeable and more compatible with paper, thus improving fixability. When the acid value is larger than 50 mgKOH/g, charge stability, particularly charge stability against environmental fluctuation, may be poor.

The hydroxyl value of the polyester resin is not particularly limited, but is preferably 5 mgKOH/g or higher.

Examples of the other resins further include a crystalline resin.

Preferred examples of the crystalline resin include those meltable at around the fixing temperature. When the toner contains such a crystalline resin, the crystalline resin melts and becomes compatible with the binder resin at the fixing temperature, thus improving sharply-melting property of the toner and exhibiting excellent low-temperature fixability.

The crystalline resin is not particularly limited and can be suitably selected to suit to a particular application as long as it has crystallinity. Examples thereof include, but are not limited to, polyester resin, polyurethane resin, polyurea resin, polyamide resin, polyether resin, vinyl resin, and modified crystalline resin. Each of these can be used alone or in combination with others.

The melting point of the crystalline resin is not particularly limited, but is preferably from 60 to 100 degrees C. When the melting point is lower than 60 degrees C., the crystalline resin is likely to start melting at low temperatures, resulting in poor heat-resistant storage stability of the toner. When the melting point is higher than 100 degrees C., the crystalline resin is not very effective for improving low-temperature fixability.

The molecular weight of the crystalline polyester resin is not particularly limited. Preferably, ortho-dichlorobenzene-soluble matter of the crystalline polyester resin has a weight average molecular weight (Mw) of from 3,000 to 30,000, a number average molecular weight (Mn) of from 1,000 to 10,000, and Mw/Mn of from 1.0 to 10, and more preferably, a weight average molecular weight (Mw) of from 5,000 to 15,000, a number average molecular weight (Mn) of from 2,000 to 10,000, and Mw/Mn of from 1.0 to 5.0, when measured by GPC. When the weight average molecular weight and the number average molecular weight are too small, heat-resistant storage stability may be poor. By contrast, when they are too large, the effect on low-temperature fixability is small. When Mw/Mn exceeds 5.0, sharply-melting property may not be sufficiently imparted to the toner.

The acid value of the crystalline polyester resin is not particularly limited, but is preferably 5 mgKOH/g or more, more preferably 10 mgKOH/g or more, for achieving a desired level of low-temperature fixability in terms of affinity for paper. On the other hand, for improving high-temperature offset resistance, the acid value is preferably 45 mgKOH/g or less.

The hydroxyl value of the crystalline polyester resin is not particularly limited, but is preferably from 0 to 50 mgKOH/g, more preferably from 5 to 50 mgKOH/g, for achieving a desired level of low-temperature fixability and a good level of chargeability.

The amount of the crystalline polyester resin in the toner is not particularly limited, but is preferably from 3 to 20 parts by mass, more preferably from 5 to 15 parts by mass, with respect to 100 parts by mass of the toner. When the amount is less than 3 parts by mass, the effect on low-temperature fixability is poor. When the amount is more than 20 parts by mass, heat-resistant storage stability, mechanical durability, and rub resistance of the toner may be poor.

### Wax

The wax is not particularly limited and can be suitably selected from known ones to suit to a particular application.

The wax may be used to prevent the glitter pigments from stacking or to widen the spacing between the planes of the glitter pigments. Preferred examples of such a wax include a wax to which a branched structure or a polar group has been introduced in its manufacturing process so that a certain degree of polarity is imparted to the wax. The melting point of the wax may be the same level as or higher than the melting temperature of the binder resin of the toner as long as it is equal to or lower than the temperature of an image being fixed on a paper sheet.

Examples of the wax include modified waxes to which a polar group, such as hydroxyl group, carboxyl group, amide group, and amino group, has been introduced. Examples of the wax further include: oxidization-modified waxes prepared by oxidizing a hydrocarbon by an air oxidization process, and metal salts (e.g., potassium salt, sodium salt) thereof; acid-group-containing polymers (e.g., maleic anhydride copolymer, alpha-olefin copolymer) and salts thereof; and alkoxylated products of hydrocarbons modified with imide ester, quaternary amine salt, or hydroxyl group.

Examples of the wax include, but are not limited to, carbonyl-group-containing wax, polyolefin wax, and long-chain hydrocarbon wax.

Examples of esterification products of the carbonyl-group-containing wax include, but are not limited to, polyalkanoic acid ester, polyalkanol ester, polyalkanoic acid amide, polyalkyl amide, and dialkyl ketone.

Specific examples of the polyalkanoic acid ester wax include, but are not limited to, carnauba wax, montan wax, trimethylolpropane tribehenate, pentaerythritol tetrabehenate, pentaerythritol diacetate dibehenate, glycerin tribehenate, and 1,18-octadecanediol distearate.

Specific examples of the polyalkanol ester include, but are not limited to, tristearyl trimellitate and distearyl maleate.

Specific examples of the polyalkanoic acid amide include, but are not limited to, dibehenylamide.

Specific examples of the polyalkyl amide include, but are not limited to, trimellitic acid tristearylamide.

Specific examples of the dialkyl ketone include, but are not limited to, distearyl ketone. Among these carbonyl-group-containing waxes, polyalkanoic acid ester is particularly preferred.

Specific examples of the polyolefin wax include, but are not limited to, polyethylene wax and propylene wax.

Specific examples of the long-chain hydrocarbon wax include, but are not limited to, paraffin wax and SASOL wax.

The melting point of the wax is not particularly limited and can be suitably selected to suit to a particular application, but is preferably from 50 to 100 degrees C., more preferably from 60 to 90 degrees C. When the melting point is 50 degrees C. or higher, heat-resistant storage stability of the toner is well maintained. When the melting point is 100 degrees C. or lower, cold offset does not occur even when the toner is fixed at a low temperature.

The melting point of the wax can be measured by, for example, a differential scanning calorimeter (TA-60WS and DSC-60 available from Shimadzu Corporation) as follows. First, about 5.0 mg of a wax is put in an aluminum sample container. The sample container is put on a holder unit and set in an electric furnace. Next, in a nitrogen atmosphere, the temperature is raised from 0 degrees C. to 150 degrees C. at a temperature rising rate of 10 degrees C./min, then lowered from 150 degrees C. to 0 degrees C. at a temperature falling rate of 10 degrees C./min, and raised again to 150 degrees C. at a temperature rising rate of 10 degrees C./min, thus obtaining a DSC curve. The DSC curve is analyzed with an analysis program installed in DSC-60, and the temperature at the largest peak of melting heat in the second heating is determined as the melting point.

Preferably, the melt viscosity of the wax is from 5 to 100 mPa·sec, more preferably from 5 to 50 mPa·sec, and particularly preferably from 5 to 20 mPa·sec, when measured at 100 degrees C. When the melt viscosity is 5 mPa·sec or higher, deterioration of releasability is prevented. When the melt viscosity is 100 mPa·sec or lower, deterioration of hot offset resistance and low-temperature releasability is effectively prevented.

The total proportion of the wax, including a wax processed into a needle-like or plate-like substance and the other waxes, in the toner is preferably from 1% to 30% by mass, more preferably from 5% to 10% by mass. When the total proportion is 5% by mass or more, deterioration of hot offset resistance of the toner is effectively prevented. When the total proportion is 10% by mass or less, deterioration of heat-resistant storage stability, chargeability, transferability, and stress resistance of the toner is effectively prevented.

The proportion of the wax as the needle-like or plate-like substance to the glitter pigment is preferably from 1% to 30% by mass, more preferably from 5% to 10% by mass.

### Colorant

The colorant that can be used in combination with the glitter pigment is not particularly limited and can be suitably selected from known colorants to suit to a particular application.

Specific examples of black colorants include, but are not limited to, carbon blacks (C.I. Pigment Black 7) such as furnace black, lamp black, acetylene black, and channel black; metals such as copper, iron (C.I. Pigment Black 11), and titanium oxide; and organic pigments such as aniline black (C.I. Pigment Black 1).

Specific examples of magenta colorants include, but are not limited to, C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 150, 163, 177, 179, 184, 202, 206, 207, 209, 211, and 269; C.I. Pigment Violet 19; and C.I. Vat Red 1, 2, 10, 13, 15, 23, 29, and 35.

Specific examples of cyan colorants include, but are not limited to, C.I. Pigment Blue 2, 3, 15, 15:1, 15:2, 15:3, 15:4, 15:6, 16, 17, and 60; C.I. Vat Blue 6; and C.I. Acid Blue 45; a copper phthalocyanine pigment having a phthalocyanine skeleton is substituted with 1 to 5 phthalimide methyl groups; and Green 7 and Green 36.

Specific examples of yellow colorants include, but are not limited to, C.I. Pigment Yellow 1, 2, 3, 4, 5, 6, 7, 10, 11, 12, 13, 14, 15, 16, 17, 23, 55, 65, 73, 74, 83, 97, 110, 139, 151, 154, 155, 180, and 185; C.I. Vat Yellow 1, 3, and 20; and Orange 36.

The proportion of the colorant in the toner is preferably from 1% to 15% by mass, more preferably from 3% to 10% by mass. When the proportion is 1% by mass or more, deterioration of coloring power of the toner is prevented. When the proportion is 15% by mass or less, defective dispersion of the colorant in the toner is prevented, and deterioration of coloring power and electrical property of the toner is effectively prevented.

The colorant may be combined with a resin to become a master batch. The resin to be combined is not particularly limited, but the binder resin or a resin having a similar structure to the binder resin is preferred for the compatibility with the binder resin.

The master batch may be obtained by mixing or kneading the resin and the colorant while applying a high shearing force thereto. To increase the interaction between the colorant and the resin, an organic solvent may be added. Alternatively, the master batch may be obtained by a method called flushing that produces a wet cake of the colorant, which can be used as it is without being dried. In the flushing method, an aqueous paste of the colorant is mixed or kneaded with the resin and the organic solvent so that the colorant is transferred to the resin side, followed by removal of the organic solvent and moisture. The mixing or kneading may be performed by a high shearing dispersing device such as a three roll mill.

### Charge Controlling Agent

The toner may contain a charge controlling agent for imparting appropriate charging ability to the toner.

Any known charge controlling agent can be used as the charge controlling agent. Since a colored material may change the color tone of the toner, colorless or whitish materials are preferably used for the charge controlling agent. Specific examples of such materials include, but are not limited to, triphenylmethane dyes, chelate pigments of molybdic acid, Rhodamine dyes, alkoxyamines, quaternary ammonium salts (including fluorine-modified quaternary ammonium salts), alkylamides, phosphorus and phosphorus-containing compounds, tungsten and tungsten-containing compounds, fluorine activators, metal salts of salicylic acid, and metal salts of salicylic acid derivatives. Each of these can be used alone or in combination with others.

The amount of the charge controlling agent is determined based on the type of the binder resin used and the toner manufacturing method (including dispersing method) and is not limited to any particular value. Preferably, the proportion of the charge controlling agent to the binder resin is from 0.01% to 5% by mass, more preferably from 0.02% to 2% by mass. When the proportion is 5% by mass or less, the charging property of the toner is not so large that the effect of the charge controlling agent can be exerted, and the electrostatic attraction force between the toner and a developing roller is reduced. Thus, a decrease of developer fluidity and deterioration of image density are effectively prevented. When the proportion is 0.01% by mass or more, charge rising property and charge quantity are sufficient.

### External Additive

For the purpose of improving fluidity, adjusting charge quantity, and/or adjusting electrical properties, various external additives may be added to the toner. The external additive is not particularly limited and can be suitably selected from known materials to suit to a particular application. Specific examples thereof include, but are not limited to, silica particles, hydrophobized silica particles, metal salts of fatty acids (e.g., zinc stearate, aluminum stearate), metal oxides (e.g., titania, alumina, tin oxide, antimony oxide) and hydrophobized products thereof, and fluoropolymers. Among these, hydrophobized silica particles, titania particles, and hydrophobized titania particles are preferred.

Specific examples of commercially-available hydrophobized silica particles include, but are not limited to, HDK H2000, HDK H2000/4, HDK H2050EP, HVK21, and HDK H1303 (available from Hoechst AG); and R972, R974, RX200, RY200, R202, R805, and R812 (available from Nippon Aerosil Co., Ltd.). Specific examples of commercially-available titania particles include, but are not limited to, P-25 (available from Nippon Aerosil Co., Ltd.); STT-30 and STT-65CS (available from Titan Kogyo, Ltd.); TAF-140 (available from Fuji Titanium Industry Co., Ltd.); and MT-150W, MT-500B, MT-600B, and MT-150A (available from TAYCA Corporation). Specific examples of commercially available hydrophobized titanium oxide particles include, but are not limited to, T-805 (available from Nippon Aerosil Co., Ltd.); STT-30A and STT-65S-S (available from Titan Kogyo, Ltd.); TAF-500T and TAF-1500T (available from Fuji Titanium Industry Co., Ltd.); MT-100S and MT-100T (available from TAYCA Corporation); and IT-S (available from Ishihara Sangyo Kaisha, Ltd.).

The hydrophobized particles of silica, titania, and alumina can be obtained by treating particles of silica, titania, and alumina, respectively, which are hydrophilic, with a silane coupling agent such as methyltrimethoxysilane, methyltriethoxysilane, and octyltrimethoxysilane. Specific examples of usable hydrophobizing agents include, but are not limited to, silane coupling agents such as dialkyl dihalogenated silane, trialkyl halogenated silane, alkyl trihalogenated silane, and hexaalkyl disilazane; silylation agents; silane coupling agents having a fluorinated alkyl group; organic titanate coupling agents; aluminum coupling agents; silicone oils; and silicone varnishes.

Preferably, primary particles of the external additive have an average particle diameter of from 1 to 100 nm, more preferably from 3 to 70 nm. When the average particle diameter is 1 nm or more, the external additive is prevented from being embedded in the toner, so that its function is effectively exhibited. When the average particle diameter is 100 nm or less, the external additive is prevented from unevenly damaging the surface of a photoconductor. The external additive may be comprised of a combination of inorganic particles with hydrophobized inorganic particles. More preferably, the external additive is comprised of at least two types of hydrophobized inorganic particles each having an average primary particle diameter of 20 nm or less and at least one type of hydrophobized inorganic particle having an average primary particle diameter of 30 nm or more. The BET specific surface area of the inorganic particles is preferably from 20 to 500 m²/g.

Preferably, the proportion of the external additive in the toner is from 0.1% to 5% by mass, more preferably from 0.3% to 3% by mass.

Examples of the external additive further include resin particles. Specific examples of the resin particles include, but are not limited to, polystyrene particles obtained by soap-free emulsion polymerization, suspension polymerization, or dispersion polymerization; particles of copolymer of methacrylates and/or acrylates; particles of polycondensation polymer such as silicone, benzoguanamine, and nylon; and thermosetting resin particles. By using such resin particles in combination, chargeability of the toner is enhanced, the amount of reversely-charged toner particles is reduced, and the degree of background fog is reduced.

The proportion of the resin particles in the toner is preferably from 0.01% to 5% by mass, more preferably from 0.1% to 2% by mass.

### Method for Manufacturing Toner

The method for manufacturing the toner and materials used for the toner can be appropriately selected from known ones as long as they meet the requirements described above. For example, the toner according to an embodiment of the present invention may be manufactured by a kneading pulverization method or a chemical method in which toner particles are granulated in an aqueous medium.

The chemical method is suitably embodied by a dissolution suspension method in which oil droplets are prepared by dissolving or dispersing a toner binder resin, a colorant, etc., in an organic solvent, or a suspension polymerization method in which radical-polymerizable monomers are used.

More preferably, the toner may be manufactured by a method including the process of dispersing an organic liquid in an aqueous medium to prepare an oil-in-water emulsion, where the organic liquid contains the glitter pigment and optionally a substance capable of being in at least one of a needle-like state or a plate-like state. As oil droplets are formed in the aqueous medium, the glitter pigments and other needle-like or plate-like particles are allowed to freely move in the oil droplets and prevented from aligned in one direction. The oil droplets thereafter become toner particles in which the glitter pigments and the needle-like or plate-like substance are fixed.

### Dissolution Suspension Method and Suspension Polymerization Method

The dissolution suspension method may include the processes of dissolving or dispersing toner components including at least a binder resin or resin precursor, a colorant, and a wax in an organic solvent to prepare an oil phase composition, and dispersing or emulsifying the oil phase composition in an aqueous medium, to prepare base particles of the toner.

Preferably, the organic solvent in which the toner components are dissolved or dispersed is a volatile solvent having a boiling point of less than 100 degrees C., for easy removal of the organic solvent in the succeeding process.

Specific examples of such organic solvents include, but are not limited to, ester-based or ester-ether-based solvents such as ethyl acetate, butyl acetate, methoxybutyl acetate, methyl cellosolve acetate, and ethyl cellosolve acetate; ether-based solvents such as diethyl ether, tetrahydrofuran, dioxane, ethyl cellosolve, butyl cellosolve, and propylene glycol monomethyl ether; ketone-based solvents such as acetone, methyl ethyl ketone, methyl isobutyl ketone, di-n-butyl ketone, and cyclohexanone; alcohol-based solvents such as methanol, ethanol, n-propanol, isopropanol, n-butanol, isobutanol, t-butanol, 2-ethylhexyl alcohol, and benzyl alcohol; and mixtures of two or more of the above solvents.

In the dissolution suspension method, at the time when the oil phase composition is dispersed or emulsified in the aqueous medium, an emulsifier or dispersant may be used, as necessary.

Examples of the emulsifier or dispersant include, but are not limited to, surfactants and water-soluble polymers. Specific examples of the surfactants include, but are not limited to, anionic surfactants (e.g., alkylbenzene sulfonate, phosphate), cationic surfactants (e.g., quaternary ammonium salt type, amine salt type), ampholytic surfactants (e.g., carboxylate type, sulfate salt type, sulfonate type, phosphate salt type), and nonionic surfactants (e.g., AO-adduct type, polyol type).

Each of these surfactants can be used alone or in combination with others.

Specific examples of the water-soluble polymers include, but are not limited to, cellulose compounds (e.g., methyl cellulose, ethyl cellulose, hydroxyethyl cellulose, ethyl hydroxyethyl cellulose, carboxymethyl cellulose, hydroxypropyl cellulose, and saponification products thereof), gelatin, starch, dextrin, gum arabic, chitin, chitosan, polyvinyl alcohol, polyvinylpyrrolidone, polyethylene glycol, polyethyleneimine, polyacrylamide, acrylic-acid-containing or acrylate-containing polymers (e.g., sodium polyacrylate, potassium polyacrylate, ammonium polyacrylate, sodium hydroxide partial neutralization product of polyacrylic acid, sodium acrylate-acrylate copolymer), sodium hydroxide (partial) neutralization product of styrene-maleic anhydride copolymer, and water-soluble polyurethanes (e.g. reaction product of polyethylene glycol or polycaprolactone diol with polyisocyanate).

In addition, the above-described organic solvents and plasticizers may be used in combination as an auxiliary agent for emulsification or dispersion.

Preferably, the toner is manufactured by granulating toner base particles by a dissolution suspension method including the process of dispersing or emulsifying an oil phase composition in an aqueous medium containing fine resin particles, where the oil phase composition contains at least a binder resin, a binder resin precursor having a functional group reactive with an active hydrogen group (“prepolymer having a reactive group”), a colorant, and a wax, to allow the prepolymer having a reactive group to react with an active-hydrogen-group-containing compound that is contained in the oil phase composition and/or the aqueous medium.

The fine resin particles may be produced by a known polymerization method, and is preferably obtained in the form of an aqueous dispersion liquid thereof.

An aqueous dispersion liquid of fine resin particles may be prepared by, for example, one of the following methods (a) to (h).

(a) Subjecting a vinyl monomer as a starting material to one of suspension polymerization, emulsion polymerization, seed polymerization, and dispersion polymerization, thereby directly preparing an aqueous dispersion liquid of fine resin particles.

(b) Dispersing a precursor (e.g., monomer, oligomer) of a polyaddition or polycondensation resin (e.g., polyester resin, polyurethane resin, epoxy resin) or a solvent solution thereof in an aqueous medium in the presence of a dispersant, and allowing the precursor to cure by application of heat or addition of a curing agent, thereby preparing an aqueous dispersion liquid of fine resin particles.

(c) Dissolving an emulsifier in a precursor (e.g., monomer, oligomer) of a polyaddition or polycondensation resin (e.g., polyester resin, polyurethane resin, epoxy resin) or a solvent solution thereof (preferably in a liquid state, may be liquefied by application of heat), and adding water thereto to cause phase-inversion emulsification, thereby preparing an aqueous dispersion liquid of fine resin particles.

(d) Pulverizing a resin produced by a polymerization reaction (e.g., addition polymerization, ring-opening polymerization, polyaddition, addition condensation, condensation polymerization) into particles by a mechanical rotary pulverizer or a jet pulverizer, classifying the particles by size to collect desired-size particles, and dispersing the collected particles in water in the presence of a dispersant, thereby preparing an aqueous dispersion liquid of fine resin particles.

(e) Spraying a solvent solution of a resin produced by a polymerization reaction (e.g., addition polymerization, ring-opening polymerization, polyaddition, addition condensation, condensation polymerization) to form fine resin particles, and dispersing the fine resin particles in water in the presence of a dispersant, thereby preparing an aqueous dispersion liquid of fine resin particles.

(f) Adding a poor solvent to a solvent solution of a resin produced by a polymerization reaction (e.g., addition polymerization, ring-opening polymerization, polyaddition, addition condensation, condensation polymerization), or cooling the solvent solution of the resin in a case in which the resin is dissolved in the solvent by application of heat, to precipitate fine resin particles, removing the solvent to isolate the fine resin particles, and dispersing the fine resin particles in water in the presence of a dispersant, thereby preparing an aqueous dispersion liquid of fine resin particles.

(g) Dispersing a solvent solution of a resin produced by a polymerization reaction (e.g., addition polymerization, ring-opening polymerization, polyaddition, addition condensation, condensation polymerization) in an aqueous medium in the presence of a dispersant, and removing the solvent by application of heat or reduction of pressure, thereby preparing an aqueous dispersion liquid of fine resin particles.

(h) Dissolving an emulsifier in a solvent solution of a resin produced by a polymerization reaction (e.g., addition polymerization, ring-opening polymerization, polyaddition, addition condensation, condensation polymerization), and adding water thereto to cause phase-inversion emulsification, thereby preparing an aqueous dispersion liquid of fine resin particles.

The fine resin particles preferably have a volume average particle diameter of from 10 to 300 nm, more preferably from 30 to 120 nm. When the volume average particle diameter of the fine resin particles is from 10 to 300 nm, deterioration of particle size distribution of the toner is effectively prevented.

Preferably, the oil phase has a solid content concentration of from 40% to 80%. When the concentration is too high, the oil phase becomes more difficult to emulsify or disperse in an aqueous medium, or to handle, due to high viscosity. When the concentration is too low, toner productivity decreases.

Toner components other than binder resin, such as colorant, wax, and master batch thereof, may be independently dissolved or dispersed in an organic solvent and thereafter mixed in a solution or dispersion liquid of the binder resin.

The aqueous medium may comprise water alone or a combination of water with a water-miscible solvent. Specific examples of the water-miscible solvent include, but are not limited to, alcohols (e.g., methanol, isopropanol, ethylene glycol), dimethylformamide, tetrahydrofuran, cellosolves (e.g., methyl cellosolve), and lower ketones (e.g., acetone, methyl ethyl ketone).

The method of dispersing or emulsifying the oil phase in the aqueous medium is not particularly limited and known equipment of low-speed shearing type, high-speed shearing type, frictional type, high-pressure jet type, or ultrasonic type may be used. For reducing the particle size of resulting particles, a high-speed shearing type is preferred. When a high-speed shearing disperser is used, the revolution is typically from 1,000 to 30,000 rpm, preferably from 5,000 to 20,000 rpm, but is not limited thereto. The dispersing temperature is typically from 0 to 150 degrees C. (under pressure) and preferably from 20 to 80 degrees C.

The organic solvent may be removed from the resulting emulsion or dispersion by a known method. For example, a method of gradually heating the whole system being stirred under normal or reduced pressure to completely evaporate the organic solvent contained in liquid droplets may be employed.

Toner base particles dispersed in the aqueous medium are washed and dried by a known method as follows. First, the dispersion is solid-liquid separated by a centrifugal separator or filter press. The resulting toner cake is re-dispersed in ion-exchange water having a temperature ranging from normal temperature to about 40 degrees C. After optionally adjusting pH by an acids or a base, the dispersion is subjected to solid-liquid separation again. These processes are repeated several times to remove impurities and surfactants. The resulting toner cake is then dried by an airflow dryer, a circulation dryer, a decompression dryer, or a vibration fluidizing dryer, thus obtaining toner particles. Undesired ultrafine particles may be removed by a centrifugal separator during the drying process. Alternatively, the particle size distribution may be adjusted by a classifier after the drying process.

The oil phase may also be prepared by replacing the organic solvent with a radical-polymerizable monomer and a polymerization initiator. As this oil phase is emulsified and the oil droplets are subjected to a polymerization by application of heat, the toner is prepared by a suspension polymerization method. Specific preferred examples of the radical-polymerizable monomer include styrene, acrylate, and methacrylate monomers. The polymerization initiator may be selected from azo initiators or peroxide initiators. The suspension polymerization method needs not include a process for removing organic solvent.

The toner base particles thus prepared may be mixed with inorganic particles, such as hydrophobic silica powder, for improving fluidity, storage stability, developability, and transferability.

The mixing of such external additive may be performed with a typical powder mixer, preferably equipped with a jacket for inner temperature control. To vary load history given to the external additive, the external additive may be gradually added or added from the middle of the mixing, while optionally varying the rotation number, rolling speed, time, and temperature of the mixer. The load may be initially strong and gradually weaken, or vice versa. Specific examples of usable mixers include, but are not limited to, V-type mixer, ROCKING MIXER, LOEDIGE MIXER, NAUTA MIXER, and HENSCHEL MIXER. The toner base particles are then allowed to pass a sieve having a mesh size of 250 or more so that coarse particles and aggregated particles are removed, thereby obtaining toner particles.

### Developer

A developer according to an embodiment of the present invention comprises at least the above-described toner and optionally other components such as a carrier.

The developer has excellent transferability and chargeability and is capable of reliably forming high-quality image. The developer may be either a one-component developer or a two-component developer.

The two-component developer may be prepared by mixing the above toner with a carrier. The proportion of the carrier in the two-component developer is not particularly limited and can be suitably selected to suit to a particular application, but is preferably from 90% to 98% by mass, more preferably from 93% to 97% by mass.

### Carrier

The carrier is not particularly limited and can be suitably selected to suit to a particular application, but the carrier preferably comprises a core material and a resin layer that covers the core material.

### Core Material

The core material is not particularly limited as long as it is comprised of magnetic particles. Specific preferred examples thereof include ferrite, magnetite, iron, and nickel. In consideration of environmental adaptability that has been remarkably advanced in recent years, manganese ferrite, manganese-magnesium ferrite, manganese-strontium ferrite, manganese-magnesium-strontium ferrite, and lithium ferrite are preferred rather than copper-zinc ferrite that has been conventionally used.

### Toner Accommodating Unit

In the present disclosure, a toner accommodating unit refers to a unit having a function of accommodating toner and accommodating the toner. The toner accommodating unit may be in the form of, for example, a toner container, a developing device, or a process cartridge.

The toner container refers to a container containing the toner.

The developing device refers to a device that accommodates toner and is configured to develop an electrostatic latent image into a toner image with the toner.

The process cartridge refers to a combined body of an electrostatic latent image bearer (also referred to as an image bearer) with a developing unit accommodating the toner, detachably mountable on an image forming apparatus. The process cartridge may further include at least one selected from a charger, an irradiator, and a cleaner.

An image forming apparatus in which the toner accommodating unit is installed can reliably form glittering images with high definition and high quality.

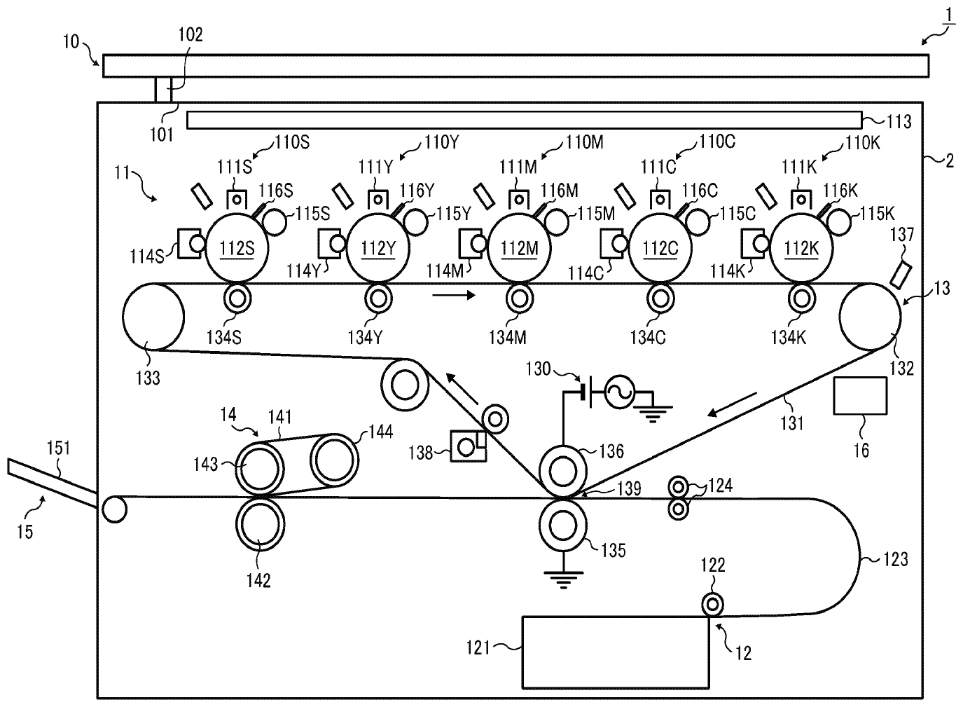

Hereinafter, a procedure for forming an image using the toner according to an embodiment of the present invention is described. The accompanied drawing is a schematic diagram illustrating an image forming apparatus according to an embodiment of the present invention. An image forming apparatus 1 illustrated in FIG. 1 is a color-image forming apparatus including a tandem image forming unit (hereinafter “image forming device”) that forms a color image. Specifically, the image forming apparatus 1 includes an image reader 10, an image forming device 11, a sheet feeder 12, a transfer device 13, a fixing device 14, a sheet ejector 15, and a processor 16.

### Image Reader 10

The image reader 10 reads an image of a document and generates image information. The image reader 10 includes a contact glass 101 and a reading sensor 102. The image reader 10 emits light to the document and receives the reflected light by a sensor such as a charge-coupled device (CCD) and a contact image sensor (CIS) to read electric color separation signals for three primary colors RGB of light.

### Image Forming Device 11

The image forming device 11 includes five image forming units 110S, 110Y, 110M, 110C, and 110K that form and output toner images of special color (S) having glittering property such as gold and silver, yellow (Y), magenta (M), cyan (C), and black (K), respectively.

The five image forming units 110S, 110Y, 110M, 110C, and 110K have the same configuration except for containing different color toners of S, Y, M, C, and K, respectively, as image forming materials, and are replaceable when their lifespans are over. The image forming units 110S, 110Y, 110M, 110C, and 110K are detachably attached to an apparatus body 2 and constitute a process cartridge. Hereinafter, the common configuration is described with reference to the image forming unit 110K for forming a K toner image as an example.

The image forming unit 110K includes a charging device 111K, a photoconductor 112K as a K toner image bearer for bearing a K toner image on the surface thereof, a developing device 114K, a charge removing device 115K, and a photoconductor cleaning device 116K. These devices are held by a common holder that is detachably attached to the apparatus body 2, so that these devices are replaceable at the same time.

The photoconductor 112K has a drum-like shape having an outer diameter of 60 mm and includes a substrate and an organic photosensitive layer formed on the surface of the substrate. The photoconductor 112K is rotationally driven counterclockwise by a driver. In the charging device 111K, a charger applies a charging bias to a charging wire that is a charging electrode of the charger to generate an electrical discharge between the charging wire and the outer circumferential surface of the photoconductor 112K, thus uniformly charging the surface of the photoconductor 112K. In the present embodiment, the photoconductor 112K is charged to the negative polarity that is the same as the charging polarity of the toner. The charging bias employed in the present embodiment is one in which an alternating current voltage is superimposed on a direct current voltage. In place of the charger, a charging roller may be disposed in contact with or in proximity to the photoconductor 112K.

The uniformly-charged surface of the photoconductor 112K is then optically scanned by laser light emitted from an exposure device 113, to be described later, thus forming an electrostatic latent image for K. Of the entire area of the uniformly-charged surface of the photoconductor 112K, the potential is attenuated at the portion irradiated with the laser light. Thus, the portion irradiated with the laser light becomes an electrostatic latent image having a potential smaller than the potential at the other portion (background portion). The electrostatic latent image for K is developed into a K toner image by the developing device 114K containing K toner, to be described later. The K toner image is then primarily transferred onto an intermediate transfer belt 131, to be described later.

The developing device 114K includes a container in which a two-component developer containing K toner and a carrier is contained. The container is internally provided with a developing sleeve, and the developer is carried on the surface of the developing sleeve by the magnetic force of a magnet roller provided inside the developing sleeve. The developing sleeve is applied with a developing bias which has the same polarity as the toner and is larger than the potential of the electrostatic latent image on the photoconductor 112K and smaller than the charging potential of the photoconductor 112K. Between the developing sleeve and the electrostatic latent image on the photoconductor 112K, a developing potential acts from the developing sleeve toward the electrostatic latent image. Further, between the developing sleeve and the background portion of the photoconductor 112K, a non-developing potential acts that causes the toner on the developing sleeve to move toward the surface of the sleeve. By the actions of the developing potential and the non-developing potential, the K toner on the developing sleeve is selectively attached to the electrostatic latent image on the photoconductor 112K, thereby developing the electrostatic latent image into a K toner image on the photoconductor 112K.

The charge removing device 115K removes the charge on the surface of the photoconductor 112K after the toner image has been primarily transferred onto the intermediate transfer belt 131. The photoconductor cleaning device 116K includes a cleaning blade and a cleaning brush and removes residual untransferred toner remaining on the surface of the photoconductor 112K that has been neutralized by the charge removing device 115K.

Referring to FIG. 1, the image forming unit 110S includes a charging device 111S, a photoconductor 112S as a special-color toner image bearer for bearing a special-color toner image on the surface thereof, a developing device 114S, a charge removing device 115S, and a photoconductor cleaning device 116S. The other image forming units 110Y, 110M, and 110C have the same configuration. Therefore, S, Y, M, and C toner images are formed on the respective photoconductors 112S, 112Y, 112M, and 112C in the respective image forming units 110S, 110Y, 110M, and 110C in the same manner as in the image forming unit 110K.

Above the image forming units 110S, 110Y, 110M, 110C, and 110K, the exposure device 113 is disposed as a latent image writing device or an exposure device. The exposure device 113 optically scans the photoconductors 112S, 112Y, 112M, 112C, and 112K with laser light emitted from a laser diode based on image information transmitted from an external device such as the image reader 10 or a personal computer.

The exposure device 113 emits laser light from a light source to the photoconductors 112S, 112Y, 112M, 112C, and 112K via a plurality of optical lenses and mirrors while polarizing the laser light in the main scanning direction by a polygon mirror that is rotationally driven by a polygon motor. In place of the laser light, light emitted from a plurality of light emitting diodes (LEDs) may be employed for optical writing.

### Sheet Feeder 12

The sheet feeder 12 supplies a sheet as the recording medium to the transfer device 13. The sheet feeder 12 includes a sheet storage 121, a sheet pickup roller 122, a sheet feeding belt 123, and a registration roller pair 124. The sheet pickup roller 122 rotates so as to move the sheet stored in the sheet storage 121 toward the sheet feeding belt 123. The sheet pickup roller 122 takes out the sheet on the top of the sheets stored, one by one, and places the sheet on the sheet feeding belt 123. The sheet feeding belt 123 conveys the sheet picked up by the sheet pickup roller 122 to the transfer device 13. The registration roller pair 124 feeds the sheet to a secondary transfer nip 139, as a transfer nip of the transfer device 13, in synchronization with entry of the portion on the intermediate transfer belt 131 where the toner image is formed to the secondary transfer nip 139.

### Transfer Device 13

The transfer device 13 is disposed below the image forming units 110S, 110Y, 110M, 110C, and 110K. The transfer device 13 includes a driving roller 132, a driven roller 133, the intermediate transfer belt 131, primary transfer rollers 134S, 134Y, 134M, 134C, and 134K, a secondary transfer roller 135, a secondary transfer facing roller 136, a toner deposition amount sensor 137, and a belt cleaning device 138.

The intermediate transfer belt 131 functions as an endless intermediate transferor. The intermediate transfer belt 131 is stretched by the driving roller 132, the driven roller 133, the secondary transfer facing roller 136, and the primary transfer rollers 134S, 134Y, 134M, 134C, and 134K, all of which are disposed inside the loop thereof. The term “disposed” is here used to mean “provided with an arrangement” or “provided to a specific position”. The term “stretched” is here used to mean “stretched over under tension”.

The driving roller 132 is rotationally driven clockwise in the drawings by a driver, so that the intermediate transfer belt 131 endlessly moves and travels in the same direction in contact with the photoconductors 112S, 112Y, 112M, 112C, and 112K.

The intermediate transfer belt 131 has a thickness of from 20 to 200 μm, preferably about 60 μm. The intermediate transfer belt 131 is preferably comprised of a carbon-dispersed polyimide resin having a volume resistivity of from 1×10⁶ to 1×10¹² Ω·cm, preferably about 1×10⁹ Ω·cm, when measured by an instrument HIRESTA UP MCPHT 45 manufactured by Mitsubishi Chemical Analytech Co., Ltd. under an applied voltage of 100 V.

The toner deposition amount sensor 137 is disposed in the vicinity of the intermediate transfer belt 131 wound around the driving roller 132. The toner deposition amount sensor 137 functions as a toner amount detector that detects the amount of the toner transferred onto the intermediate transfer belt 131. The toner deposition amount sensor 137 is a light reflection photosensor. The toner deposition amount sensor 137 measures the amount of toner deposition by detecting the amount of light reflected from the toner image (including special-color toner) deposited and formed on the intermediate transfer belt 131. The toner deposition amount sensor 137 may also function as a toner concentration sensor as a conventional toner concentration detector that detects and measures the toner concentration. In such a case, there is no need to provide another toner amount detector, so that the number of parts can be reduced to contribute to cost reduction. Alternatively, the toner deposition amount sensor 137 may be disposed at a position where the toner image on the photoconductor 112 can be detected, in place of the position facing the intermediate transfer belt 131.

The primary transfer rollers 134S, 134Y, 134M, 134C, and 134K are disposed facing the respective photoconductors 112S, 112Y, 112M, 112C, and 112K with the intermediate transfer belt 131 interposed therebetween, and are driven to rotate so as to move the intermediate transfer belt 131. As a result, the front surface of the intermediate transfer belt 131 come into contact (or abutment) with each of the photoconductors 112S, 112Y, 112M, 112C, and 112K to form primary transfer nips. Each of the primary transfer rollers 134S, 134Y, 134M, 134C, and 134K is applied with a primary transfer bias by a primary transfer bias power supply. Thus, the primary transfer bias is established between the S, Y, M, C, and K toner images on the respective photoconductors 112S, 112Y, 112M, 112C, and 112K and the respective primary transfer rollers 134S, 134Y, 134M, 134C, and 134K. The color toner images are then sequentially transferred onto the intermediate transfer belt 131.

The S toner image formed on the surface of the photoconductor 112S enters the primary transfer nip for S as the photoconductor 112S rotates. The S toner image is then primarily transferred from the photoconductor 112S onto the intermediate transfer belt 131 due to the action of the transfer bias and the nip pressure. The intermediate transfer belt 131 onto which the S toner image has been primarily transferred then sequentially passes the primary transfer nips for Y, M, C, and K. Next, the Y, M, C, and K toner images on the respective photoconductors 112Y, 112M, 112C, and 112K are sequentially primarily transferred onto the S toner image in an overlapping manner. As a result of the primary transfer in an overlapping manner, a composite toner image is formed on the intermediate transfer belt 131, which includes a color toner image and a special-color toner image having glittering property such as a gold toner image and a silver toner image. In other words, the toner images respectively carried on the surfaces of the color toner image bearer and the special-color toner image bearer are superimposed on and transferred onto the intermediate transfer belt 131.

Each of the primary transfer rollers 134S, 134Y, 134M, 134C, and 134K is an elastic roller comprised of a core metal and a conductive sponge layer fixed on the surface of the core metal. The elastic roller has an outer diameter of 16 mm and the core metal has a diameter of 10 mm. The resistance value R of the sponge layer was calculated from the current I that flows upon application of a voltage of 1,000 V to the core metal of each of the primary transfer rollers 134S, 134Y, 134M, 134C, and 134K with the sponge layer pressed by a grounded metal roller having an outer diameter of 30 mm with a force of 10 N. Specifically, the resistance value R of the sponge layer calculated based on the Ohm's law (R=V/I) from the current I that flows upon application of a voltage of 1,000 V to the core metal is about 3×10⁷Ω. Each of the primary transfer rollers 134S, 134Y, 134M, 134C, and 134K is then applied with a primary transfer bias output from the primary transfer bias power supply under a constant current control. In place of the primary transfer rollers 134S, 134Y, 134M, 134C, and 134K, a transfer charger or a transfer brush may be employed.

The secondary transfer roller 135 sandwiches the intermediate transfer belt 131 and the sheet with the secondary transfer facing roller 136 and is rotationally driven by a driver. The secondary transfer roller 135 is in contact with the front surface of the intermediate transfer belt 131 to form the secondary transfer nip 139 as a transfer nip. The secondary transfer roller 135 also functions as a nip forming member and a transfer member that transfers a toner image from the intermediate transfer belt onto the sheet as a recording medium sandwiched in the secondary transfer nip. The secondary transfer facing roller 136 functions as a nip forming member and a facing member. While the secondary transfer roller 135 is grounded, the secondary transfer facing roller 136 is applied with a secondary transfer bias by a secondary transfer bias power supply 130.

The secondary transfer bias power supply 130 includes both a direct-current power supply and an alternating-current power supply, and is able to output a direct-current voltage superimposed with an alternating-current voltage as the secondary transfer bias. The output terminal of the secondary transfer bias power supply 130 is connected to the core metal of the secondary transfer facing roller 136. The potential of the core metal of the secondary transfer facing roller 136 is substantially the same as the voltage output from the secondary transfer bias power supply 130.

As the secondary transfer bias is applied to the secondary transfer facing roller 136, a secondary transfer bias is formed between the secondary transfer facing roller 136 and the secondary transfer roller 135 that electrostatically moves the toner having the negative polarity from the secondary transfer facing roller 136 side toward the secondary transfer roller 135 side. As a result, the toner having the negative polarity on the intermediate transfer belt 131 can be moved from the secondary transfer facing roller 136 side to the secondary transfer roller 135 side.

The secondary transfer bias power supply 130 uses a direct-current component which has the same negative polarity as the toner and makes the time-averaged potential of the superimposition bias the same negative polarity as the toner. Here, instead of grounding the secondary transfer roller 135 while applying the superimposition bias to the secondary transfer facing roller 136, the core metal of the secondary transfer facing roller 136 may be grounded while applying the superimposition bias to the secondary transfer roller 135. In this case, the polarities of the direct-current voltage and the direct-current component are made different.

In the case of using a sheet having a large surface unevenness such as an embossed sheet, the toner is made to reciprocate by application of the above-described superimposition bias to be relatively moved from the intermediate transfer belt 131 side to the sheet side, thus being transferred onto the sheet. As a result, transferability onto concave portions on the sheet can be improved to improve the transfer rate and to prevent the production of abnormal images such as hollow defects. On the other hand, in the case of using a sheet having a small unevenness such as a normal transfer sheet, since a light and dark pattern that follows the unevenness pattern does not appear, sufficient transferability is achieved only by applying a secondary transfer bias based only on a direct-current component.

The secondary transfer facing roller 136 is comprised of a core metal made of stainless steel, aluminum, or the like, and a resistance layer stacked thereon. The secondary transfer facing roller 136 has the following characteristics. The outer diameter is about 24 mm. The diameter of the core metal is about 16 mm. The resistance layer may be comprised of a polycarbonate, fluorine-based rubber, or silicon-based rubber in which conductive particles such as carbon and a metal complex is dispersed, a rubber such as NBR (nitrile rubber) and EPDM (ethylene-propylene-diene monomer), a rubber of NBR/ECO (epichlorohydrin rubber) copolymer, or a semiconducting rubber made of polyurethane. The volume resistance of the resistance layer is from 10⁶ to 10¹²Ω, preferably from 10⁷ to 10⁹Ω. Either foamed types having a rubber hardness (ASKER-C) of from 20 to 50 degrees or rubber types having a rubber hardness (ASKER-C) of from 30 to 60 degrees may be used. In particular, since the resistance layer contacts the secondary transfer roller 135 via the intermediate transfer belt 131, sponge types that do not produce non-contact portions even with a small contact pressure are preferable. On the intermediate transfer belt 131 that has passed through the secondary transfer nip after the secondary transfer, residual toner that has not been transferred onto the sheet is remaining. The residual toner is removed from the surface of the intermediate transfer belt 131 by the belt cleaning device 138 provided with a cleaning blade that is in contact with the surface of the intermediate transfer belt 131.

### Fixing Device 14

The fixing device 14 employs a belt fixing system and is configured with a pressure roller 142 pressed against a fixing belt 141 that is an endless belt. The fixing belt 141 is wound around a fixing roller 143 and a heating roller 144, and at least one of the rollers is provided with a heat source or heater (e.g., heater, lamp, electromagnetic induction heater). The fixing belt 141 is nipped and pressed between the fixing roller 143 and the pressure roller 142, thus forming a fixing nip between the fixing belt 141 and the pressure roller 142.

The sheet fed into the fixing device 14 is nipped by the fixing nip with the surface bearing an unfixed toner image in close contact with the fixing belt 141. The toner in the toner image is then softened by heat and pressure, thus fixing the toner image. The sheet having the toner image thereon is ejected outside the apparatus. In the case of further forming an image on the opposite side of the sheet to which the toner image has been transferred, the sheet is conveyed and reversed by a sheet reversing mechanism after the toner image has been fixed thereon. Another toner image is then formed on the opposite side of the sheet in the same manner as in the above-described image forming process.

The sheet on which the toner has been fixed by the fixing device 14 is ejected outside the image forming apparatus body 2 via an output roller constituting the sheet ejector 15 and is stored in a sheet storage 151 such as an output tray.

### EXAMPLES

The embodiments of the present invention are further described in detail with reference to the following Examples but are not limited to these Examples. In the following descriptions, “parts” represents “parts by mass” and “%” represents “% by mass” unless otherwise specified.

### Production Example 1

### Polyester Resin (A) (Prepolymer)

### Production of Reactive Precursor (a1) of Polyester Resin (A)

In a reaction vessel equipped with a condenser tube, a stirrer, and a nitrogen introducing tube, 3-methyl-1,5-pentanediol as a diol component, sebacic acid as a dicarboxylic acid component, and 0.5% by mol of trimellitic anhydride (based on all the monomers) were put in such amounts that the molar ratio of hydroxyl groups to carboxyl groups (OH/COOH) became 1.6. Further, 1,000 ppm of tetrabutyl orthotitanate as a condensation catalyst (based on all the monomers) was put in the vessel. The temperature was raised to 200 degrees C. over a period of 2 hours under nitrogen flow and further raised to 230 degrees C. over a period of 2 hours, and a reaction was conducted for 3 hours while distilling off the produced water. The reaction was further continued under reduced pressures of from 5 to 15 mmHg for 5 hours. Thus, an intermediate polyester 1 having a weight average molecular weight of 7,500 was prepared.

Next, in a reaction vessel equipped with a condenser tube, a stirrer, and a nitrogen introducing tube, the intermediate polyester 1 and isophorone diisocyanate (IPDI) were put in such amounts that the molar ratio (NCO/OH) of isocyanate groups in IPDI to hydroxyl groups in the intermediate polyester 1 became 2.0, then dissolved in ethyl acetate, thus preparing a 50% ethyl acetate solution. After that, the ethyl acetate solution was heated to 80 degrees C. under nitrogen flow and subjected to a reaction for 5 hours. Thus, an ethyl acetate solution of a reactive precursor (a1) that is a reactive precursor of the polyester resin (A) was prepared.

In the Examples described later, the reactive precursor (a1) reacts with an amine, at the time of production of a toner, to produce an amine-extended product. It is difficult to take out the amine-extended product of the reactive precursor (a1) from the resulting toner and measure its physical properties. Accordingly, under the same conditions as those in producing the amine-extended product of the reactive precursor (a1) at the time of production of the toner, another amine-extended product of the reactive precursor (a1) was produced in the below-describer manner, and the glass transition temperature thereof was determined from a DSC curve obtained in the first temperature rise in DSC.

### Preparation of Amine-Extended Product of Reactive Precursor (a1)

The reactive precursor (a1) was mixed with ethyl acetate to prepare a 20% ethyl acetate solution thereof, and a 20% ethyl acetate solution of isophoronediamine (IPDA) was dropped therein such that the molar ratio (NH₂/NCO) of isocyanate groups in the reactive precursor (a1) to amino groups in IPDA became 1.1, followed by sufficient stirring. The resulted ethyl acetate solution of the amine-extended product was cast on a petri dish made of TEFLON (registered trademark), dried at 80 degrees C. for 10 hours, and further dried at 120 degrees C. under reduced pressures of 10 kPa or less to sufficiently remove the solvent. Thus, an amine-extended product of the reactive precursor (a1) was prepared.

The glass transition temperature of the amine-extended product of the reactive precursor (a1), determined from the DSC curve obtained in the first temperature rise in DSC, was −70 degrees C.

### Production of Reactive Precursor (a2) of Polyester Resin (A)

In a reaction vessel equipped with a condenser tube, a stirrer, and a nitrogen introducing tube, 3-methyl-1,5-pentanediol as a diol component, terephthalic acid and adipic acid (in a molar ratio of 55:45) as dicarboxylic acid components, and 0.5% by mol of trimellitic anhydride (based on all the monomers) were put in such amounts that the molar ratio of hydroxyl groups to carboxyl groups (OH/COOH) became 1.5. Further, 1,000 ppm of tetrabutyl orthotitanate as a condensation catalyst (based on all the monomers) was put in the vessel. The temperature was raised to 200 degrees C. over a period of 2 hours under nitrogen flow and further raised to 230 degrees C. over a period of 2 hours, and a reaction was conducted for 3 hours while distilling off the produced water. The reaction was further continued under reduced pressures of from 5 to 15 mmHg for 5 hours. Thus, an intermediate polyester 2 having a weight average molecular weight of 10,000 was prepared.

Next, in a reaction vessel equipped with a condenser tube, a stirrer, and a nitrogen introducing tube, the intermediate polyester 2 and isophorone diisocyanate (IPDI) were put in such amounts that the molar ratio (NCO/OH) of isocyanate groups in IPDI to hydroxyl groups in the intermediate polyester 2 became 2.0, then dissolved in ethyl acetate, thus preparing a 50% ethyl acetate solution. After that, the ethyl acetate solution was heated to 80 degrees C. under nitrogen flow and subjected to a reaction for 5 hours. Thus, an ethyl acetate solution of a reactive precursor (a2) that is a reactive precursor of the polyester resin (A) was prepared.

An amine-extended product of the reactive precursor (a2) was prepared in the same manner as the amine-extended product of the reactive precursor (a1), and the glass transition temperature thereof was measured.

The glass transition temperature of the amine-extended product of the reactive precursor (a2), determined from the DSC curve obtained in the first temperature rise in DSC, was −35 degrees C.

### Production Example 2

### Amorphous Polyester Resin (B)

### Synthesis of Amorphous Polyester Resin B1

In a reaction vessel equipped with a condenser tube, a stirrer, and a nitrogen introducing tube, diol components including ethylene oxide 2-mol adduct of bisphenol A and propylene oxide 2-mol adduct of bisphenol A (in a molar ratio of 50:50) and dicarboxylic acid components including terephthalic acid and adipic acid (in a molar ratio of 80:20) were put in such amounts that the molar ratio of hydroxyl groups to carboxyl groups (OH/COOH) became 1.2. Further, 1,000 ppm of tetrabutyl orthotitanate as a condensation catalyst (based on all the monomers) was put in the vessel. The temperature was raised to 230 degrees C. over a period of 2 hours, and a reaction was conducted for 5 hours while distilling off the produced water. The reaction was further continued under reduced pressures of from 5 to 15 mmHg for 5 hours. Thus, an amorphous polyester resin (B1) having a weight average molecular weight of 4,000 was prepared.

### Synthesis of Amorphous Polyester Resin B2

In a reaction vessel equipped with a condenser tube, a stirrer, and a nitrogen introducing tube, diol components including ethylene oxide 2-mol adduct of bisphenol A and propylene oxide 3-mol adduct of bisphenol A (in a molar ratio of 30:70), dicarboxylic acid components including terephthalic acid and adipic acid (in a molar ratio of 80:20), and 3.5% by mol of trimethylolpropane (based on all the monomers) were put in such amounts that the molar ratio of hydroxyl groups to carboxyl groups (OH/COOH) became 1.2. Further, 1,000 ppm of tetrabutyl orthotitanate as a condensation catalyst (based on all the monomers) was put in the vessel. The temperature was raised to 230 degrees C. over a period of 2 hours, and a reaction was conducted for 5 hours while distilling off the produced water. After that, the reaction was continued under reduced pressures of from 5 to 15 mmHg for 5 hours, and the reaction system was cooled to 180 degrees C. Next, 1.0% by mol of trimellitic anhydride (based on all the monomers) and 200 ppm of tetrabutyl orthotitanate (based on all the monomers) were further put in the vessel, and the reaction was conducted at 180 degrees C. for 1 hours and subsequently under reduced pressures of from 5 to 20 mmHg for 3 hours. Thus, an amorphous polyester resin (B2) having a weight average molecular weight of 9,000 was prepared.

### Production Example 3

### Synthesis of Crystalline Polyester Resin (C)

In a reaction vessel equipped with a condenser tube, a stirrer, and a nitrogen introducing tube, 1,6-hexanediol as a diol component and sebacic acid as a dicarboxylic acid component were put in such amounts that the molar ratio of hydroxyl groups to carboxyl groups (OH/COON) became 1.2.

Further, 500 ppm of titanium tetraisopropoxide (based on all the monomers) was put in the vessel. The temperature was raised to 180 degrees C. over a period of 2 hours, and a reaction was conducted for 8 hours while distilling off the produced water. Next, while the temperature was gradually raised to 200 degrees C., the reaction was continued under nitrogen flow for 3 hours while distilling off the produced water, under reduced pressures of from 5 to 20 mmHg. Thus, a crystalline polyester resin (C) having a melting point of 67 degrees C. and a weight average molecular weight of 20,000 was prepared.

### Preparation of Crystalline Polyester Resin (C) Dispersion Liquid

In a reaction vessel equipped with a condenser tube, a thermometer, and a stirrer, 10 parts of the crystalline polyester resin (C) and 90 parts of ethyl acetate were put and heated to 80 degrees C. while being stirred for sufficient dissolution.

After being cooled to 30 degrees C., the resulting solution was subjected to a wet pulverization treatment using a bead mill ULTRAVISCOMILL (available from AIMEX CO., Ltd.) filled with 80% by volume of zirconia beads having a diameter of 0.5 mm, at a liquid feeding speed of 1 kg/hour and a disc peripheral speed of 6 m/sec, for 6 passes. After that, ethyl acetate was added thereto to prepare a crystalline polyester resin (C) dispersion liquid having a solid content concentration of 10%.

### Production Example 4

### Synthesis of Wax Dispersing Agent

In a reaction vessel equipped with a stirrer and a thermometer, 480 parts of xylene and 100 parts of a paraffin wax HNP-9 (available from Nippon Seiro Co., Ltd.) were put and heated until they were dissolved. After the air in the vessel was replaced with nitrogen gas, the temperature was raised to 170 degrees C. Next, a mixture liquid of 740 parts of styrene, 100 parts of acrylonitrile, 60 parts of butyl acrylate, 36 parts of di-t-butyl peroxyhexahydroterephthalate, and 100 parts of xylene was dropped in the vessel over a period of 3 hours, and the temperature was kept at 170 degrees C. for 30 minutes. The solvent was thereafter removed. Thus, a wax dispersing agent was prepared.

### Preparation of Wax Dispersion Liquid

In a reaction vessel equipped with a stirrer and a thermometer, 100 parts of an ester wax LW-12 (available from Sanyo Chemical Industries, Ltd.), 40 parts of the wax dispersing agent, and 300 parts of ethyl acetate were put and heated to 80 degrees C. while being stirred for sufficient dissolution. The resulting solution was then cooled to 30 degrees C. and subjected to a dispersion treatment using a bead mill ULTRAVISCOMILL (available from AIMEX CO., Ltd.) filled with 80% by volume of zirconia beads having a diameter of 0.5 mm at a liquid feeding speed of 1 kg/hour and a disc peripheral speed of 6 m/sec, for 3 passes. Thus, a wax dispersion liquid was prepared. The particle diameter of the wax dispersion liquid was 350 nm when measured by an instrument LA-920 available from HORIBA, Ltd. (The solid content concentration of the wax was 20%.)

### Production Example 5

### Preparation of Organically-modified Layered Inorganic Compound Master Batch

First, 200 parts of water, 500 parts of an organically-modified layered inorganic compound (CLAYTONE APA available from BYK Japan KK), and 500 parts of the amorphous polyester resin B1 were mixed with a HENSCHEL MIXER (manufactured by Mitsui Mining Co., Ltd.). The mixture was kneaded with a double roll at 120 degrees C. for 30 minutes, then rolled to cool, and pulverized with a pulverizer. Thus, an organically-modified layered inorganic compound master batch was prepared.

### Production Example 6

### Synthesis of Fine Organic Particle Emulsion (Fine Particle Dispersion Liquid)

In a reaction vessel equipped with a stirrer and a thermometer, 683 parts of water, 16 parts of a sodium salt of sulfate of ethylene oxide adduct of methacrylic acid (ELEMINOL RS-30 available from Sanyo Chemical Industries, Ltd.), 83 parts of styrene, 83 parts of methacrylic acid, 110 parts of n-butyl acrylate, and 1 part of ammonium persulfate were put and stirred at a revolution of 400 rpm for 15 minutes. Next, the temperature was raised to 75 degrees C. and a reaction was conducted for 5 hours. A 1% by mass aqueous solution of ammonium persulfate in an amount of 30 parts was further put in the vessel, and an aging was conducted at 75 degrees C. for 5 hours. Thus, a fine particle dispersion liquid was prepared, which was an aqueous dispersion liquid of a vinyl resin (i.e., a copolymer of styrene, methacrylic acid, and a sodium salt of a sulfate of ethylene oxide adduct of methacrylic acid).

The volume average particle diameter of the fine particle dispersion liquid, measured by an instrument LA-920 (available from HORIBA, Ltd.), was 0.14 μm.

### Production Example 7

### Preparation of Aqueous Phase

An aqueous phase was prepared by stir-mixing 2,240 parts of water, 80 parts of the fine particle dispersion liquid, 80 parts of a 48.5% aqueous solution of sodium dodecyl di phenyl ether disulfonate (ELEMINOL MON-7 available from Sanyo Chemical Industries, Ltd.), and 200 parts of ethyl acetate. The aqueous phase was a milky white liquid.

### Production Example 8

### Preparation of Glitter Pigment

### Production of Glitter Pigment 1

A 10% ethyl acetate solution of methacrylate polymer was applied to a polyester film support using a commercial gravure printing method. The solvent was evaporated to form a high-molecular-weight polymer film (release layer) having a uniform basis weight of from 0.1 to 0.7 g/m², to give a specific surface roughness to the surface of the polyester film.

On the polyester film coated with the methacrylate polymer (release layer), aluminum was vacuum-deposited at from 0.02 to 0.0001 mbar to form an aluminum layer having a thickness of about 210 nm. After this vacuum deposition, the coated polyester sheet was put in ethyl acetate to dissolve the release layer, thus obtaining crushed aluminum flakes. After the solid content concentration was adjusted to 10%, the aluminum flakes were further pulverized using an instrument ULTRA-TURRAX.

The pulverization was continued until the average particle diameter reached the desired particle diameter of 15 μm. The acrylic resin was removed through three times of filtration and washing. A glitter pigment 1 dispersion liquid was prepared such that the solid content concentration of aluminum in ethyl acetate was adjusted to 10%.

### Production of Glitter Pigment 7

The procedure in preparing the glitter pigment 1 was repeated until the release layer had been formed, then the following procedures (1) to (5) were conducted to prepare a glitter pigment 7 having a resin coating layer.

(1) Preparation of Resin Composition for Coating Layer

The following components were blended to prepare a resin composition for a coating layer.
Mixture of polyester resin and ketone resin: 5 parts
Isocyanate: 10 parts
Butyl acetate: 45 parts
Ethyl acetate: 15 parts
Methyl ethyl ketone: 15 parts
Cyclohexanone 10 parts

(2) The above-prepared resin composition was applied to the surface of the release layer such that the thickness became 0.3 μm after drying, then dried at 100 degrees C. for 1 minute, thus forming a coating layer.

(3) On the surface of the coating layer, an aluminum-deposited layer was formed by vacuum deposition in the same manner as the glitter pigment 1.

(4) On the surface of the aluminum-deposited layer, a coating layer of the resin composition was further laminated.

(5) The resulted film was peeled off at the release layer and subjected to the aftertreatment in the same manner as the glitter pigment 1.

### Production of Glitter Pigments 2 to 6, 8, and 9

The procedure for preparing the glitter pigment 1 was repeated except for changing the average surface roughness of the release layer, the vapor deposition time, and the crushing time. Thus, glitter pigments 2 to 6, 8, and 9 were prepared, each different in surface roughness, pigment thickness, and average particle diameter from one another.

In the Examples, the glitter pigments 1 to 9 were used, each of which was comprised of vapor-deposited aluminum flakes.

Properties of the glitter pigments 1 to 9 are presented in Table 1.

TABLE 1

| | Properties of Glitter Pigment | | | |
|---|---|---|---|---|
| | Average | | | |
| | Surface | Pigment | Average | |
| | Roughness | Thick- | Particle | |
| | Ra | ness | Diameter | Resin |
| | (nm) | (nm) | (μm) | Coating |
| Glitter Pigment 1 | 95 | 210 | 15 | No |
| Glitter Pigment 2 | 65 | 210 | 15 | No |
| Glitter Pigment 3 | 65 | 20 | 8 | No |
| Glitter Pigment 4 | 60 | 190 | 15 | No |
| Glitter Pigment 5 | 60 | 100 | 12 | No |
| Glitter Pigment 6 | 60 | 30 | 8 | No |
| Glitter Pigment 7 | 55 | 100 | 12 | Yes |
| Glitter Pigment 8 | 115 | 215 | 15 | No |
| Glitter Pigment 9 | 120 | 190 | 15 | No |

### Example 1

First, 83 parts of the amorphous polyester resin (B1), 50 parts of the crystalline polyester resin (C) dispersion liquid, 35 parts of the wax dispersion liquid, 2 parts of the organically-modified layered inorganic compound master batch, 30 parts of the glitter pigment 1 were sufficiently stirred, and further stirred by a TK HOMOMIXER (available from PRIMIX Corporation) at a revolution of 6,000 rpm for uniform dissolution and dispersion. Further, isophoronediamine (IPDA) in such an amount that the molar ratio (NH₂/NCO) of amino groups in IPDA to isocyanate groups in the reactive precursor (a1) became 0.98 was put therein and stirred using a TK HOMOMIXER at a revolution of 6,000 rpm for 15 seconds. Next, 10 parts by mass of a 50% ethyl acetate solution of the reactive precursor (a1) were put therein and stirred using a TK HOMOMIXER at a revolution of 6,000 rpm for 30 seconds. Thus, an oil phase 1 (having a solid content concentration of 50%) was prepared. In a vessel equipped with a stirrer and a thermometer, 174 parts of the aqueous phase was put and kept at 20 degrees C. in a water bath.

The above-prepared oil phase 1 was added to the aqueous phase and mixed using a TK HOMOMIXER (available from PRIMIX Corporation) at a liquid temperature of 20 degrees C. and a revolution of 8,000 rpm for 2 minutes. Thus, an emulsion slurry was prepared. As a result of observation with an optical microscope, the resulting oil droplets were in a slightly elliptical shape.

The slurry was mixed by a TK HOMOMIXER (available from PRIMIX Corporation) at a revolution of 8,000 rpm for 5 minutes while keeping the temperature at 40 degrees C., thus applying a shearing stress to the slurry. As a result of observation with an optical microscope, the resulting oil droplets were in a nearly spherical shape. The solvent was further removed from the slurry at 40 degrees C. under reduced pressures, thus obtaining a slurry containing 0% of volatile components of the organic solvent.

The slurry was thereafter cooled to room temperature and filtered under reduced pressures. Next, 200 parts of ion-exchange water was added to the filter cake and mixed by a THREE-ONE MOTOR (available from Shinto Scientific Co., Ltd.) at 800 rpm for 5 minutes for re-slurry, followed by filtration. Next, 10 parts of a 1% by mass aqueous solution of sodium hydroxide and 190 parts of ion-exchange water were added to the filter cake for re-slurry, followed by filtration. Next, 10 parts of a 1% by mass aqueous solution of hydrochloric acid and 190 parts of ion-exchange water were added to the filter cake for re-slurry, followed by filtration. Next, 300 parts of ion-exchange water was added to the filter cake for re-slurry, followed by filtration. This operation was repeated twice.

The filter cake was dried by a circulating air dryer at 45 degrees C. for 48 hours and sieved with a mesh having an opening of 75 μm. Thus, toner base particles were prepared.

Next, 100 parts of the toner base particles, 1 part of a hydrophobized silica HDK-2000 (available from Wacker Chemie AG), and 1 part of a surface-treated titanium oxide JMT-1501B (available from Tayca Corporation) were mixed by a HENSCHEL MIXER (manufactured by Mitsui Mining Co., Ltd.) at a peripheral speed of 30 m/s for 30 seconds, followed by a pause for 1 minute. This operation was repeated 5 times. The mixture was sieved with a mesh having an opening of 35 μm. Thus, a toner 1 was prepared.

### Example 2

An oil phase 2 and toner base particles 2 were prepared in the same manner as in Example 1 except for replacing the glitter pigment 1 with the glitter pigment 2. A toner 2 was prepared in the same manner as in Example 1 except for replacing the toner base particles 1 with the toner base particles 2.

### Example 3

An oil phase 3 and toner base particles 3 were prepared in the same manner as in Example 1 except for replacing the glitter pigment 1 with the glitter pigment 3. A toner 3 was prepared in the same manner as in Example 1 except for replacing the toner base particles 1 with the toner base particles 3.

### Example 4

An oil phase 4 and toner base particles 4 were prepared in the same manner as in Example 1 except for replacing the glitter pigment 1 with the glitter pigment 4. A toner 4 was prepared in the same manner as in Example 1 except for replacing the toner base particles 1 with the toner base particles 4.

### Example 5

An oil phase 5 and toner base particles 5 were prepared in the same manner as in Example 1 except for replacing the glitter pigment 1 with the glitter pigment 5. A toner 5 was prepared in the same manner as in Example 1 except for replacing the toner base particles 1 with the toner base particles 5.

### Example 6

An oil phase 6 and toner base particles 6 were prepared in the same manner as in Example 1 except for replacing the glitter pigment 1 with the glitter pigment 6. A toner 6 was prepared in the same manner as in Example 1 except for replacing the toner base particles 1 with the toner base particles 6.

### Example 7

An oil phase 7 and toner base particles 7 were prepared in the same manner as in Example 1 except for replacing the glitter pigment 1 with the glitter pigment 7. A toner 7 was prepared in the same manner as in Example 1 except for replacing the toner base particles 1 with the toner base particles 7.

### Example 8

An oil phase 8 and toner base particles 8 were prepared in the same manner as in Example 7 except for replacing the reactive precursor (a1) with the reactive precursor (a2) and replacing the amorphous polyester resin (B1) with the amorphous polyester resin (B2). A toner 8 was prepared in the same manner as in Example 7 except for replacing the toner base particles 7 with the toner base particles 8.

### Example 9

An oil phase 9 and toner base particles 9 were prepared in the same manner as in Example 8 except for changing the amount of the reactive precursor (a2) from 5 parts to 10 parts and changing the amount of the amorphous polyester resin (B2) from 83 parts to 78 parts. A toner 9 was prepared in the same manner as in Example 8 except for replacing the toner base particles 8 with the toner base particles 9.

### Comparative Example 1

An oil phase 10 and toner base particles 10 were prepared in the same manner as in Example 1 except for replacing the glitter pigment 1 with the glitter pigment 8. A toner 10 was prepared in the same manner as in Example 1 except for replacing the toner base particles 1 with the toner base particles 10.

### Comparative Example 2

An oil phase 11 and toner base particles 11 were prepared in the same manner as in Example 1 except for replacing the glitter pigment 1 with the glitter pigment 9. A toner 11 was prepared in the same manner as in Example 1 except for replacing the toner base particles 1 with the toner base particles 11. The compositions of the toner base particles are presented in Table 2.

### Production of Developers 1 to 11

The carrier in an amount of 100 parts and the toner 1 in an amount of 7 parts were uniformly mixed by a TURBLA mixer (available from Willy A. Bachofen AG), configured to perform stirring by rolling of a container, at a revolution of 48 rpm for 5 minutes. Thus, a developer 1, which was a two-component developer, was prepared.

Developers 2 to 11 were prepared in the same manner as the developer 1 except for replacing the toner 1 with the toners 2 to 11, respectively.

Using the developers 1 to 11, the fixable temperature range of the toner, image peeling, and glittering property were evaluated by in the following manner. Toner properties are presented in Table 3, and the evaluation results are presented in Table 4.

It is clear from Tables 3 and 4 that the above-described conventional problems can be solved and the object of the present invention can be achieved by the embodiments of the present invention.

### Evaluation Methods

Hereinafter, the procedures for evaluating the quality of toners and images are described in detail.

### Fixable Temperature Range

The evaluation was carried out using a color production printer RICOH PRO C7200S manufactured by Ricoh Co., Ltd. A solid image having a toner deposition amount of 0.85±0.1 mg/cm² (with an image size of 3 cm×8 cm) was formed on multiple sheets of a transfer paper (printing paper <70> available from Ricoh Japan Co., Ltd.) at a position 3.0 cm away from the leading end of each sheet in the sheet feeding direction. The solid image was fixed on each sheet with variety of temperatures of the fixing belt.

The lower-limit fixable temperature was defined as the lowest temperature at which the offset hardly occurs (i.e., the number of offset occurrences was less than 5). The upper-limit fixable temperature was defined as the highest temperature at which a decrease in gloss from the maximum gloss was 10% or less. The fixable temperature range was defined as the difference between the lower-limit fixable temperature and the upper-limit fixable temperature. The wider the fixable temperature range, the better the fixability.

### Fixed Image Peeling Rank

A solid image fixed at the lower-limit fixable temperature, in the same manner as in the above evaluation of the fixable temperature range, was subjected to a scratch drawing test using a drawing tester AD-401 (available from Ueshima Seisakusho Co., Ltd.) equipped with a ruby needle (having a point radius of from 260 to 320 μmR and a point angle of 60 degrees) at a load of 50 g. The surface of the image was then strongly rubbed with a piece of a fabric (HONEYCOTT #440 available from Honeylon KK) for 10 times, and the degree of peeling was ranked according to the following criteria.

Evaluation Criteria

Rank 5: Image is not peeled off.

Rank 4: The scratched portion is slightly peeled off.

Rank 3: Half of the scratched portion is peeled off.

Rank 2: All of the scratched portion is peeled off.

Rank 1: Portions other than the scratched portion are also peeled off.

### Glittering Property Rank Evaluation 1

Each developer containing each toner was set in an image forming apparatus and subjected to the evaluations of metallicity of the image as described below. The results are presented in Table 4.

Using a commercially-available image forming apparatus IMAGIO NEO C600 (from Ricoh Co., Ltd.), a solid image having a toner deposition amount of 0.50±0.02 mg/cm² (with an image size of 3 cm×8 cm) was formed on a sheet of POD GLOSS COAT PAPER available from Oji Paper Co., Ltd. The solid image was formed on a position 3.0 cm away from the leading end of the sheet in the sheet feeding direction. The speed of the sheet passing through the nip portion of the fixing device was 146 rpm, and the fixing temperature was 180 degrees C.

As an index for evaluating metallicity of the resulted toner-fixed image, a flop index (indicating color change depending on viewing angle) was used.

The flop index is calculated by the following formula. The value of lightness (L*) required for the calculation was measured using a multi-angle colorimeter (BYK-mac i). Here, L*15° represents a lightness measured at an angle of 15° with respect to the image, L*45° represents a lightness measured at an angle of 45° with respect to the image, and L*110° represents a lightness measured at an angle of 110° with respect to the image. The higher the flop index, the greater the color change depending on the viewing angle, and therefore the higher the metallicity.

2.69×(L*15°−L*110°)1.11/(L*45°)0.86 (Formula)

Based on the above-determined flop index, metallicity was evaluated based on the following evaluation criteria.

Evaluation Criteria

Rank 5: The flop index is 7.5 or more.

Rank 4: The flop index is 6.5 or more and less than 7.5.

Rank 3: The flop index is 5.5 or more and less than 6.5.

Rank 2: The flop index is 4.5 or more and less than 5.5.

Rank 1: The flop index is less than 4.5.

### Glittering Property Rank Evaluation 2

Each developer containing each toner was set in an image forming apparatus and subjected to the evaluations of metallicity of the image as described below. The results are presented in Table 4.

Using a commercially-available image forming apparatus IMAGIO NEO C600 (from Ricoh Co., Ltd.), a solid image having a toner deposition amount of 0.50±0.02 mg/cm² (with an image size of 3 cm×8 cm) was formed on a sheet of POD GLOSS COAT PAPER available from Oji Paper Co., Ltd. The solid image was formed on a position 3.0 cm away from the leading end of the sheet in the sheet feeding direction. The speed of the sheet passing through the nip portion of the fixing device was 73 rpm, and the fixing temperature was 180 degrees C.

As an index for evaluating metallicity of the resulted toner-fixed image, a flop index (indicating color change depending on viewing angle) was used.

The flop index is calculated by the following formula. The value of lightness (L*) required for the calculation was measured using a multi-angle colorimeter (BYK-mac i). Here, L*15° represents a lightness measured at an angle of 15° with respect to the image, L*45° represents a lightness measured at an angle of 45° with respect to the image, and L*110° represents a lightness measured at an angle of 110° with respect to the image. The higher the flop index, the greater the color change depending on the viewing angle, and therefore the higher the metallicity.

2.69×(L*15°−L*110°)1.11/(L*45°)0.86

Based on the above-determined flop index, metallicity was evaluated based on the following evaluation criteria.

Evaluation Criteria

Rank 5: The flop index is 9.5 or more.

Rank 4: The flop index is 8.5 or more and less than 9.5.

Rank 3: The flop index is 7.5 or more and less than 8.5.

Rank 2: The flop index is 6.5 or more and less than 7.5.

Rank 1: The flop index is less than 6.5.

TABLE 2

| | | | | | Amorphous Polyester Resin | | | | Wax | | Colorant |
|---|---|---|---|---|---|---|---|---|---|---|---|
| Example/ | | | Polyester Resin (A) | | (B) | | Crystalline | Wax | Dispersing | APA | Master |
| Comparative | | | Reactive | (parts | | (parts | Resin (C) | (parts | Agent | (parts | Batch |
| Example | Toner | Glitter | Precursor | by | | by | (parts by | by | (parts by | by | (parts by |
| No. | No. | Pigment | Type | mass) | Resin Type | mass) | mass) | mass) | mass) | mass) | mass) |
| Example 1 | Toner 1 | Glitter | Reactive | 5 | Amorphous | 83 | 5 | 5 | 2 | 1 | 15 |
| | | Pigment 1 | Precursor (a1) | | Polyester Resin (B1) | | | | | | |
| Example 2 | Toner 2 | Glitter | Reactive | 5 | Amorphous | 83 | 5 | 5 | 2 | 1 | 15 |
| | | Pigment 2 | Precursor (a1) | | Polyester Resin (B1) | | | | | | |
| Example 3 | Toner 3 | Glitter | Reactive | 5 | Amorphous | 83 | 5 | 5 | 2 | 1 | 15 |
| | | Pigment 3 | Precursor (a1) | | Polyester Resin (B1) | | | | | | |
| Example 4 | Toner 4 | Glitter | Reactive | 5 | Amorphous | 83 | 5 | 5 | 2 | 1 | 15 |
| | | Pigment 4 | Precursor (a1) | | Polyester Resin (B1) | | | | | | |
| Example 5 | Toner 5 | Glitter | Reactive | 5 | Amorphous | 83 | 5 | 5 | 2 | 1 | 15 |
| | | Pigment 5 | Precursor (a1) | | Polyester Resin (B1) | | | | | | |
| Example 6 | Toner 6 | Glitter | Reactive | 5 | Amorphous | 83 | 5 | 5 | 2 | 1 | 15 |
| | | Pigment 6 | Precursor (a1) | | Polyester Resin (B1) | | | | | | |
| Example 7 | Toner 7 | Glitter | Reactive | 5 | Amorphous | 83 | 5 | 5 | 2 | 1 | 15 |
| | | Pigment 7 | Precursor (a1) | | Polyester Resin (B1) | | | | | | |
| Example 8 | Toner 8 | Glitter | Reactive | 5 | Amorphous | 83 | 5 | 5 | 2 | 1 | 15 |
| | | Pigment 7 | Precursor (a2) | | Polyester Resin (B2) | | | | | | |
| Example 9 | Toner 9 | Glitter | Reactive | 10 | Amorphous | 78 | 5 | 5 | 2 | 1 | 15 |
| | | Pigment 7 | Precursor (a2) | | Polyester Resin (B2) | | | | | | |
| Comparative | Toner 10 | Glitter | Reactive | 5 | Amorphous | 83 | 5 | 5 | 2 | 1 | 15 |
| Example 1 | | Pigment 8 | Precursor (a1) | | Polyester Resin (B1) | | | | | | |
| Comparative | Toner 11 | Glitter | Reactive | 5 | Amorphous | 83 | 5 | 5 | 2 | 1 | 15 |
| Example 2 | | Pigment 9 | Precursor (a1) | | Polyester Resin (B1) | | | | | | |

TABLE 3

| | | Properties | Properties of | |
|---|---|---|---|---|
| | | of Toner | THF-insoluble Matter | |
| Example/ | | Weight | Glass | |
| Comparative | | Average | Transition | |
| Example | Toner | Molecular | Temperature | Proportion |
| No. | No. | Weight | (deg. C.) | (%) |
| Example 1 | Toner 1 | 6000 | −70 | 4.2 |
| Example 2 | Toner 2 | 6000 | −70 | 4.2 |
| Example 3 | Toner 3 | 6000 | −70 | 4.2 |
| Example 4 | Toner 4 | 6000 | −70 | 4.2 |
| Example 5 | Toner 5 | 6000 | −70 | 4.2 |
| Example 6 | Toner 6 | 6000 | −70 | 4.2 |
| Example 7 | Toner 7 | 6000 | −70 | 4.2 |
| Example 8 | Toner 8 | 9500 | −35 | 4.1 |
| Example 9 | Toner 9 | 9500 | −35 | 6.1 |
| Comparative | Toner 10 | 6000 | −70 | 4.2 |
| Example 1 | | | | |
| Comparative | Toner 11 | 6000 | −70 | 4.3 |
| Example 2 | | | | |

TABLE 4

| Example/ | | | Fixable | | Glittering | Glittering | |
|---|---|---|---|---|---|---|---|
| Comparative | | | Temperature | Image | Property | Property | |
| Example | Toner | Developer | Range | Peeling | Evaluation 1 | Evaluation 2 | Overall |
| No. | No. | No. | (deg. C.) | Rank | Rank | Rank | Evaluation |
| Example 1 | Toner | Developer | 35 | 3 | 2 | 2 | 7 |
| | 1 | 1 | | | | | |
| Example 2 | Toner | Developer | 35 | 3 | 3 | 2 | 8 |
| | 2 | 2 | | | | | |
| Example 3 | Toner | Developer | 35 | 3 | 3 | 3 | 9 |
| | 3 | 3 | | | | | |
| Example 4 | Toner | Developer | 35 | 3 | 4 | 2 | 9 |
| | 4 | 4 | | | | | |
| Example 5 | Toner | Developer | 35 | 3 | 4 | 3 | 10 |
| | 5 | 5 | | | | | |
| Example 6 | Toner | Developer | 35 | 3 | 4 | 4 | 11 |
| | 6 | 6 | | | | | |
| Example 7 | Toner | Developer | 35 | 3 | 5 | 5 | 13 |
| | 7 | 7 | | | | | |
| Example 8 | Toner | Developer | 40 | 4 | 5 | 5 | 14 |
| | 8 | 8 | | | | | |
| Example 9 | Toner | Developer | 45 | 5 | 5 | 5 | 15 |
| | 9 | 9 | | | | | |
| Comparative | Toner | Developer | 35 | 2 | 1 | 1 | 3 |
| Example 1 | 10 | 10 | | | | | |
| Comparative | Toner | Developer | 35 | 2 | 1 | 2 | 5 |
| Example 2 | 11 | 11 | | | | | |

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A toner for developing an electrostatic image, comprising:
a binder resin; and
a glitter pigment having an average surface roughness Ra of 100 nm or less.

2. The toner according to claim 1, wherein the glitter pigment is a flat-plate-like pigment having a thickness of from 25 to 200 nm.

3. The toner according to claim 1, wherein the glitter pigment comprises a metal and a resin.

4. The toner according to claim 1,
wherein tetrahydrofuran-soluble matter of the toner has a weight average molecular weight (Mw) of from 5,000 to 14,000, measured by gel permeation chromatography (GPC),
wherein the binder resin comprises a polyester resin (A) insoluble in tetrahydrofuran,
wherein tetrahydrofuran-insoluble matter of the toner has a glass transition temperature (Tg) of from −60 to 10 degrees C., determined from a DSC curve obtained in a first temperature rise in differential scanning calorimetry (DSC).

5. The toner according to claim 4, wherein a proportion of the tetrahydrofuran-insoluble matter in the toner is from 5% to 15% by mass.

6. The toner according to claim 4, wherein the polyester resin (A) has at least one of urethane bond and urea bond.

7. The toner according to claim 4, wherein:
the polyester resin (A) comprises an alcohol component as a constitutional component,
the alcohol component includes an aliphatic diol having 3 to 10 carbon atoms in an amount of 50% by mol or more of the alcohol component, and
the aliphatic diol has a structure represented by the following general formula (1):
HOCR₁R₂ₙOH General Formula (1)
where R₁ and R₂ each independently represent hydrogen atom or an alkyl group having 1 to 3 carbon atoms, n represents an odd number of from 3 to 9, and each of R₁ and R₂ in each repeating unit is either the same as or different from R₁ and R₂, respectively, in another repeating unit.

8. The toner according to claim 1, wherein the toner has a circularity of from 0.950 to 0.985.

9. A toner accommodating unit comprising:
a container; and
the toner according to claim 1 accommodated in the container.

10. An image forming apparatus comprising:
an electrostatic latent image bearer;
an electrostatic latent image forming device configured to form an electrostatic latent image on the electrostatic latent image bearer;
a developing device containing the toner according to claim 1, configured to develop the electrostatic latent image formed on the electrostatic latent image bearer with the toner to form a toner image;
a transfer device configured to transfer the toner image formed on the electrostatic latent image bearer onto a surface of a recording medium; and
a fixing device configured to fix the toner image on the surface of the recording medium.
